(19) United States
(12) Patent Application Publication
(10) Pub. No.: US 2023/0286409 A1
(43) Pub. Date: Sep. 14, 2023

(54) TECHNIQUES FOR BALANCING AN ELECTRIC LOAD OF A SYSTEM BY ESTIMATING POWER LOSSES OF DC CHARGING STATIONS OF THE SYSTEM

(71) Applicant: ENEL X S.R.L., ROME (IT)

(72) Inventors: Daniel Feldman, New York, NY (US); Amanpreet Kaur, San Francisco, CA (US); Vincent Schachter, Paris (FR)

(21) Appl. No.: 17/654,373

(22) Filed: Mar. 10, 2022

(51) Int. Cl. B60L 53/67; B60L 53/63; B60L 53/66

(52) U.S. Cl. CPC B60L 53/67; B60L 53/63; B60L 53/66; B60L 2210/30

(57) ABSTRACT

This disclosure discusses systems, methods, and techniques for charging a plurality of electric vehicles (EVs). In one aspect, a system may include a plurality of electric vehicle supply equipment (EVSE), and the EVSEs are coupled between a power grid and the EVs. The system may also include a plurality of power meters, and a respective power meter may measure an amount of power received from a respective EV. The system may determine an instance of communication connectivity between the system and the EVs. After establishing communication, the system may communicate with the EVs using any communication protocol and/or standard. The communication may then enable the system to receive EV characteristics, for example, a state of charge of each EV. Based on the EV characteristics, the system may then determine power conversion efficiencies of each EVSE. By so doing, the system can determine power losses associated with each EVSE. Finally, based on the EV characteristics, the power losses associated with each EVSE, and/or a power availability, for example, from the power grid, the system may balance power loads associated with the EVSEs and/or the EVs.

### TECHNICAL FIELD

The present disclosure generally relates to the field of configuring an electric vehicle supply equipment (EVSE). More particularly, the present disclosure describes systems, methods, and techniques for configuring a plurality of EVSEs to provide electric charge to a plurality of electric vehicles (EVs).

### BACKGROUND

Driving an electric vehicle (EV) may include some remarkable benefits compared to driving a vehicle with a combustion engine. To this end, industry and academia strive to increase the benefits of driving the EV, in part, by improving an electric vehicle supply equipment (EVSE) that supplies electric charge to the EV. Currently, the industry has adopted a level one (“Level 1”), a level two (“Level 2”), and a level three (“Level 3”) EVSE.

The Level 1 and Level 2 EVSEs supply an alternating current to the EV. When charging at a Level 1 or a Level 2 EVSE, the EV converts the alternating current (AC) to a direct current (DC) using an AC-to-DC converter located inside the EV (e.g., an onboard AC-to-DC converter) to charge a battery of the EV. Due to physical constraints, the onboard AC-to-DC converter of the EV may be relatively small. Further, in certain regions, such as in the United States of America, the Level 1 EVSE may be plugged, connected, and/or coupled (herein collectively may be referred to as “coupled”) to a 120 volts AC (v_{AC}) receptacle. The 120 v_{AC} receptacle may carry and/or support a relatively low amount of current (e.g., approximately 12 to 16 Amperes (A)). Thus, the relatively small onboard AC-to-DC converter and the relatively low amount of current can limit an amount of power being transferred from the Level 1 EVSE to the battery of the EV. Consequently, a charging speed of the Level 1 EVSE may be considerably low. Specifically, when using the Level 1 EVSE, the battery of the EV may receive approximately enough charge to enable the EV to drive six to eight kilometers (6 to 8 km) per hour spent charging at the Level 1 EVSE.

To increase the charging speed, a driver of the EV may utilize a Level 2 EVSE. In certain regions, the Level 2 EVSE may be coupled to a 240 v_{AC} receptacle. When using the Level 2 EVSE, the battery of the EV may receive, for example, approximately enough charge to enable the EV to drive 20 to 100 kilometers per hour spent charging at the Level 2 EVSE. Therefore, the Level 2 EVSE may support considerably higher charging speeds compared to the Level 1 EVSE. The Level 2 EVSEs may be installed at and/or in a residential area (e.g., a home). The Level 2 EVSEs may be installed at and/or in an establishment, such as a public charging station, an office building, a store, a manufacturing facility, and/or so forth.

To increase the charging speeds even further than the Level 2 EVSEs, the driver of the EV may utilize a Level 3 EVSE. The Level 3 EVSE may be referred to as a “DC EVSE,” a “DC charging station,” or a “DC Fast Charging (DCFC) station.” The DC charging station utilizes DC charging. To do so, the DC charging station may perform an AC-to-DC power conversion before power enters the EV. Therefore, the DC charging stations may have an on-site AC-to-DC converter, which enables the DC charging station to bypass the onboard AC-to-DC converter of the EV, and the DC charging station can charge the battery of the EV directly. Drivers of the EVs may prefer to use the DC charging stations, saving them time charging their EVs. Therefore, it may be desirable to increase the benefits offered by the DC charging stations.

### SUMMARY

This disclosure discusses systems, methods, and techniques for charging a plurality of EVs. In one aspect, a system may include a plurality of EVSEs coupled to a power grid to provide electrical power to the EVs. The system may communicate with the EVs to receive EV characteristics, for example, a state of charge (SoC) of each EV. Based on the EV characteristics, the system can determine power conversion efficiencies of each EVSE. The power conversion efficiencies can enable determining power losses associated with each EVSE. Finally, based on the EV characteristics, the power losses associated with each EVSE, and/or a power availability, for example, from the power grid, the system may balance power loads associated with the EVSEs and/or the EVs.

### BRIEF DESCRIPTION OF THE DRAWINGS

The present embodiments will become more fully apparent from the following description, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 is a diagram of a system with a plurality of EVSEs that are used for charging a plurality of EVs simultaneously, according to one embodiment.

FIG. 2 illustrates a power grid providing power to a plurality of establishments, the establishments being charging stations, according to one embodiment.

FIG. 3 illustrates another system with a plurality of EVSEs that are used for charging a plurality of EVs simultaneously, the EVSEs being AC charging stations, according to one embodiment.

FIG. 4 illustrates another system with a plurality of EVSEs that are used for charging a plurality of EVs simultaneously, the EVSEs being DC charging stations, according to one embodiment.

FIG. 5 shows an example graph of illustrative power conversion efficiency curves of a plurality of EVSEs, the EVSEs being DC charging stations, according to one embodiment.

FIG. 6 illustrates another system with a plurality of EVSEs that are used for charging a plurality of EVs simultaneously, according to one embodiment, the EVSEs being DC charging stations, and the system may use a front-of-the-meter (FTM) electric power and/or a behind-the-meter (BTM) electric power.

FIG. 7 illustrates another system with a plurality of EVSEs that are used for charging a plurality of EVs simultaneously, according to one embodiment, the EVSEs being DC charging stations, and each EVSE being capable to charge at least two EVs.

FIG. 8 illustrates a flow diagram for determining power losses associated with each EVSE of the plurality of EVSEs, according to one embodiment.

FIG. 9 illustrates a flow diagram for performing electric load balancing of a plurality of EVSEs and associated EVs that are receiving charge from the plurality of EVSEs, according to one embodiment.

### DETAILED DESCRIPTION

This disclosure discusses systems, methods, and techniques for charging a plurality of EVs. According to one embodiment, a system may include a plurality of EVSEs. The EVSEs may be coupled between a power grid and the EVs. The system may also include a plurality of user-side power meters, and a respective user-side power meter may measure an amount of power received from a respective EV. The system may determine an instance of communication connectivity between the system and the EVs. After establishing communication, the system may communicate with the EVs using any communication protocol and/or standard. The communication may then enable the system to receive EV characteristics, for example, an SoC of each EV. Based on the EV characteristics, the system may then determine power conversion efficiencies of each EVSE. By so doing, the system can determine power losses associated with each EVSE. Finally, based on the EV characteristics, the power losses associated with each EVSE, and/or a power availability, for example, from the power grid, the system may balance power loads associated with the EVSEs and/or the EVs.

According to another embodiment, a computer-implemented method may include determining an instance of communication connectivity between a system and a plurality of EVs. The method may be implemented by or in conjunction with the system that can include a plurality of EVSEs that are coupled between a power grid and the EVs. The method may be implemented by or in conjunction with the system, which also includes a plurality of user-side power meters to measure an amount of power being received from each EV. Then, the method includes the system communicating with the EVs using any communication protocol and/or standard. By so doing, the method enables the system to receive EV characteristics from each EV, including an SoC of each EV. Based on the EV characteristics, the method may then determine power conversion efficiencies with each EVSE and, consequently, power losses with each EVSE. Finally, based on the EV characteristics, the power losses associated with each EVSE, and/or a power availability, for example, from the power grid, the method may balance a power load associated with the EVSEs and/or the EVs.

In some embodiments, a system, an apparatus, a software, an algorithm, a model, and/or means include performing the computer-implemented method mentioned above.

This disclosure includes simplified concepts for using EVSEs (or charging stations) to charge the EVs, which is further described below. For brevity and ease of description, the disclosure focuses on power loads associated with or being EVs and/or EVSEs. However, the techniques, method, and systems described herein are not limited to EVs and/or EVSEs. Therefore, the techniques, method, and systems described herein may be used to balance a variety of electrical power loads.

It will be readily understood that the components of the embodiments, as generally described and illustrated in the figures herein, may be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Moreover, the phrases “connected to” and “coupled to” are used herein in their ordinary sense and are broad enough to refer to any suitable coupling or other forms of interaction between two or more entities, including electrical, mechanical, fluid, and/or thermal interaction. Two components may be coupled to each other even though they are not in direct contact with each other. The phrase “attached to” refers to interaction between two or more entities that are in direct contact with each other and/or are separated from each other only by a fastener of any suitable variety (e.g., an adhesive).

The terms “a” and “an” can be described as one, but are not limited to one. For example, although the disclosure may recite an element having, e.g., “a line of stitches,” the disclosure also contemplates that the element can have two or more lines of stitches.

Unless otherwise stated, all ranges include both endpoints and all numbers between the endpoints.

For consistency and broad international understanding, throughout this disclosure, units of measurements may be expressed using le Système International d'Unités (the International System of Units, abbreviated from the French as the “SI” units), or may be colloquially referred to as the “metric system.” In addition to, or alternatively of, it is to be understood that the techniques and systems described herein may operate using other units, for example, units defined in the United States Customary System (USCS).

The terms “charge,” “energy,” and “power,” for example, “electric charge,” “electric energy,” and “electric power,” may be used interchangeably, in part, because these terms may be related. Further, the terms “power” and/or “electric power” may be expressed in units of Watts (VV) and/or a derivative thereof, for example, kilowatt-hour (kWh). Persons having ordinary skill in art can infer and/or differentiate these terms based on context, industry usage, academic usage, linguistic choice, and/or other factors.

For decimal separators and thousand(s) separators, this disclosure generally uses an English-speaking (e.g., the United States of America) number formatting instead of, for example, a Continental-European number formatting. As such, two dollars and thirty-two cents may be written as “$2.32.” Similarly, two euros and thirty-two cents may also be written as “€2.32.” Also, when using the USCS units, one million and ninety-two pounds (e.g., weight units in USCS) may be written as “1,000,092 lb.” Likewise, even when using the SI units, one million and ninety-two kilograms may also be written as “1,000,092 kg.”

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment. Not every embodiment is shown in the accompanying illustrations; however, at least a preferred embodiment is shown. At least some of the features described for a shown preferred embodiment are present in other embodiments.

Alternatively of, or in addition to, the terms “an embodiment” or “the embodiment,” this disclosure may also include the terms “an aspect” or “the aspect,” depending on a linguistic choice, for example, to lower the repetitiveness of the terms “an embodiment” or “the embodiment.” Therefore, the terms “an aspect” and “an embodiment” may be synonymous with each other.

The term electric vehicle (EV), as used herein, refers to a motorized vehicle deriving locomotive power, either full-time or part-time, from an electric system onboard the motorized vehicle. By way of non-limiting examples, an EV may be an electrically powered passenger vehicle for road use; an electric scooter; an electric forklift; a cargo-carrying vehicle powered, full-time or part-time, by electricity; an off-road electrically powered vehicle; an electrically powered watercraft; and so forth. The EV may also utilize an autonomous-driving application software and/or driver-assistance application software.

The term electric vehicle supply equipment (EVSE), as used herein, refers to equipment by which an EV may be charged or recharged. An EVSE may comprise or be coupled to a computing system whereby service to the EV is provisioned, optionally, according to parameters (e.g., operator-selectable parameters). Also, an EVSE may comprise a means of providing cost accounting and may further comprise a payment acceptance component. An EVSE may be installed at a home of an owner/operator of an EV, at a place of business for an owner/operator of an EV, at a fleet facility for a fleet comprising one or more EVs, at a public charging station, etc. The present disclosure uses the terms EVSE and “charging station” interchangeably. Where appropriate, however, the present disclosure differentiates an AC charging station from a DC charging station.

According to some embodiments, a power conversion efficiency of an EVSE (e.g., a DC charging station) may be a ratio of an output DC power (P_{DC}) of the DC charging station and an input AC power (p_{AC}) to the DC charging station from, for example, a power grid. For clarity and brevity, for a relatively constant p_{AC} to the DC charging station and a relatively constant output DC current (I_{DC}) of the DC charging station, the power conversion efficiency increases with an output DC voltage (V_{DC}) of the DC charging station. The output DC voltage (V_{DC}) of the DC charging station, however, approximately equals and/or may depend on a voltage of the battery of the EV. Further, the voltage of the battery of the EV may depend on an SoC of the battery of the EV. Specifically, a higher SoC of the battery may result in a higher voltage of the battery of the EV. Consequently, according to one embodiment, the power conversion efficiency of the DC charging station may increase with time as the battery of the EV receives more charge from the DC charging station.

In one aspect, information regarding the SoC of the EV may be obtained from a computing device, such as an in-vehicle infotainment (IVI), a smartphone, a tablet, a server, and/or so forth. The computing device may also include a user interface (UI) and may store a media access control (MAC) address of the EV. Embodiments of the present disclosure include application software that may associate this MAC address of the EV with a profile of the EV stored in a database. The application software may be configured to detect changes of the profile of the EV, such as a change in the SoC of the battery (e.g., 10%, 25%, 50%, 75%, 90%, full charge) in real time, in near real time, and/or in time intervals (e.g., every T minute(s), where T is a positive integer). This detection may be transmitted to and/or from the EV, the EVSE (e.g., the DC charging station), and/or a network of EVSEs using various wired and/or wireless communication protocols and/or standards. Communication between the EV, the EVSE, and/or the network of EVSEs may aid in load balancing, as is further described below.

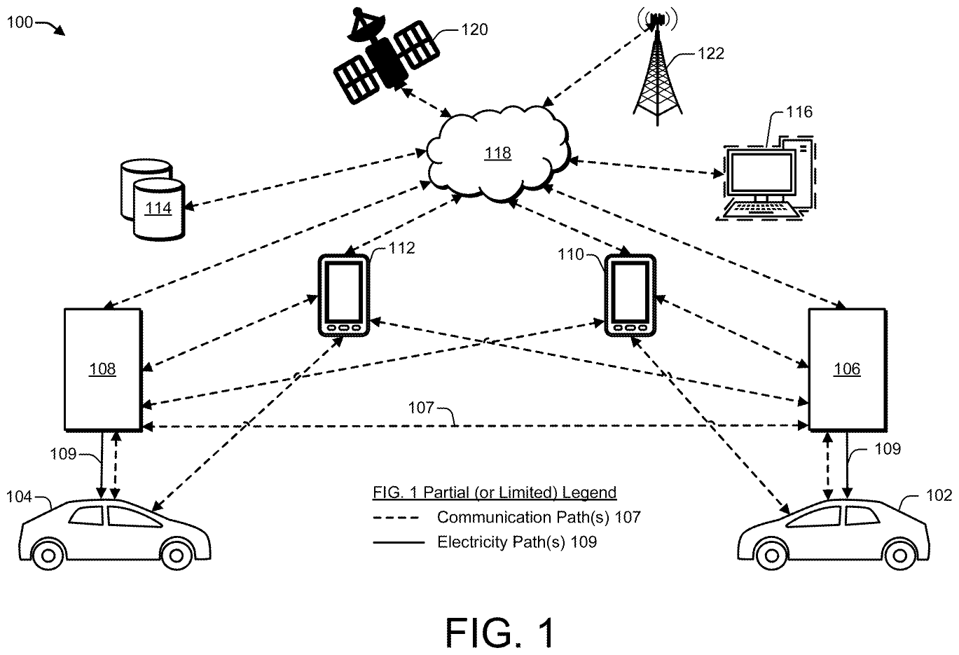

FIG. 1 illustrates an example system 100 for charging a plurality of EVs, according to one embodiment. The EVs may include a first EV 102 (EV 102), a second EV 104 (EV 104), and/or other EVs (not illustrated in FIG. 1). To enable simultaneous charging of the EVs, the system 100 may include a plurality of EVSEs. For example, the system 100 may include a first EVSE 106 (EVSE 106), a second EVSE 108 (EVSE 108), and/or additional EVSEs (not illustrated in FIG. 1). In FIG. 1, the EVSE 106 may provide electricity (e.g., electric charge, electric energy, electric power) to a battery of the EV 102. Similarly, the EVSE 108 may provide electricity to a battery of the EV 104. In FIG. 1, communication signals (or communication path(s) 107) are illustrated with dashed lines, and flow of power and/or current from the EVSE to respective EVs (or electricity path(s) 109) are illustrated with solid lines.

In one embodiment, the system 100 may include a first computing device 110 (computing device 110) that may be associated with the EV 102 and a second computing device 112 (computing device 112) that may be associated with the EV 104. For example, the computing devices 110, 112 may be respective IVI systems of the EVs 102, 104. The IVI systems and their associated UIs may enhance a driving or riding experience by incorporating features, such as an SoC of the battery of the EV (e.g., EV 102, EV 104), navigation, directions to an available AC charging station, directions to an available DC charging station, traffic information, a rear dashcam, parking assistance, handsfree phone, radio stations, and/or other features. For these features, the computing devices 110 and 112 may utilize navigation, autonomous-driving, driver-assistance, and/or other application software.

The computing devices 110, 112 may be implemented as any other suitable computing or other electronic device. In some embodiments, the computing devices 110, 112 may be or may include a smartphone, a navigation device, a media device, a laptop computer, a network-attached storage (NAS) device, a desktop computer, a tablet computer, a computer server, a smart appliance, a cellular base station, a broadband router, an access point, a gaming device, an internet-of-things (IoT) device, a sensor, a security device, an asset tracker, a fitness management device, a wearable device, a wireless power device, and so forth.

In some embodiments, each of the computing devices 110, 112 include at least one application processor (processor) and at least one computer-readable medium. The processor may include any type of processor, such as a central processing unit (CPU) or a multi-core processor configured to execute instructions (e.g., code, pseudocode, algorithms, application software) that may be stored in the computer-readable medium. The computer-readable medium may include any suitable data storage media, for example, non-volatile memory (e.g., flash memory), volatile memory (e.g., random-access memory (RAM)), optical media, magnetic media (e.g., disc or tape), and so forth. Moreover, the computer-readable medium does not include transitory propagating signals or carrier waves.

In some embodiments, the system 100 includes one or more databases 114. For example, the database 114 may store data from or used by one or more of the EVs (e.g., EV 102, EV 104), the EVSE 106, the EVSE 108, the computing device 110, the computing device 112, and/or another computing device 116 that is associated with, part of, and/or embedded in the system 100 (system computing device 116). The data may be profile data for a driver and/or the EV 102 and/or EV 104 reflecting information (e.g., make, model, vehicle identification number (VIN), MAC address, SoC) of the EV 102 and/or the EV 104 operated by, owned by, or otherwise associated with respective drivers.

In some embodiments, the system computing device 116 may be a remote computing device (e.g., a server, a controller, a cloud computer, and/or so forth) that communicates with the EV 102, the EV 104, the EVSE 106, the EVSE 108, the computing device 110, the computing device 112, and/or the database 114 directly and/or via a network 118. Like the computing devices 110 and 112, the system computing device 116 may include a processor and a computer-readable medium, where the computer-readable medium of the system computing device 116 may store the instructions. In some embodiments, the system computing device 116 determines whether a particular user (e.g., EV driver, occupant, rider, or person associated with the EV) is authorized to charge or have the EV (e.g., EV 102, EV 104) charged at a particular EVSE (e.g., EVSE 106, EVSE 108). For example, the system computing device 116 may process data, such as driver identification data, security token data, SoC data of the EV 102 and the EV 104, power conversion efficiency data of the EVSE 106 and/or the EVSE 108, make and model of the EV 102 and/or the EV 104, driving efficiency of the EV 102 and/or the EV 104, traffic information, power load capacity at the EVSE 106 and/or the EVSE 108, trip data, past driving behavior data, the time of the day, the day of the week, the week of the month, the month of the year, energy rates (cost), a power load, and so forth from the EV 102, the EV 104, the EVSE 106, the EVSE 108, the computing device 110, the computing device 112, a power grid, and/or the database 114 to determine whether a user is authorized to charge or have the EV 102 and/or the EV 104 charged at the EVSE 106 and/or the EVSE 108, as is further described below.

In some embodiments, the system computing device 116 may be configured to control charging of the EV 102 and/or the EV 104, determine an estimated SoC(s) of the EV 102 and/or the EV 104, and guide respective drivers of the EV 102 and/or the EV 104 to the EVSE 106, the EVSE 108, and/or another EVSE (not illustrated in FIG. 1). In one aspect, the EVSE 106 may have a first location, and the EVSE 108 may have a second location. At the first location, the EVSE 106 may be coupled to a first distribution line of a power grid, a first transformer of the power grid, a first switchgear of a first establishment (e.g., a first public charging station), a first circuit breaker inside the first switchgear, and/or so forth. Similarly, at the second location, the EVSE 108 may be coupled to a second distribution line of the power grid, a second transformer of the power grid, a second switchgear of a second establishment, a second circuit breaker inside the second switchgear, and/or so forth. In another aspect, the EVSEs 106 and 108 may be co-located and may receive AC power from a same distribution line of the power grid, a same transformer of the power grid, a same switchgear of a same establishment, a same circuit breaker inside the same switchgear, and/or so forth.

In some embodiments, the network 118 may facilitate communication between an EV (e.g., EV 102, EV 104), an EVSE (e.g., EVSE 106, EVSE 108), the database 114, a respective computing device 110, 112, the system computing device 116, a satellite(s) 120, and/or a base station(s) 122. Communication(s) in the system 100 may be performed using various protocols and/or standards. Examples of such protocols and standards include an Open Charge Point Protocol (OCPP), such as OCPP 1.6, OCPP 2.0, OCPP 2.0.1; a 3rd Generation Partnership Project (3GPP) Long-Term Evolution (LTE) standard, such as a 4th Generation (4G) or a 5th Generation (5G) cellular standard; an Institute of Electrical and Electronics (IEEE) 802.11 standard, such as IEEE 802.11g, ac, ax, ad, aj, or ay (e.g., Wi-Fi 6® or WiGig®); an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); other protocols and standards established or maintained by various governmental, industry, and/or academia consortiums, organizations, and/or agencies; and so forth. Therefore, the network 118 may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In addition to, or alternatively of, the communications illustrated in FIG. 1, the system 100 may facilitate other unidirectional, bidirectional, wired, wireless, direct, and/or indirect communications utilizing one or more communication protocols and/or standards. In some embodiments, the computing device 110 communicates with the EV 102, the EVSE 106, and the EVSE 108 directly (e.g., via Bluetooth Classic® or a different short-range communication protocol) and/or indirectly (e.g., via the network 118). In some embodiments, the computing device 112 communicates with the EV 104, the EVSE 106, and the EVSE 108 directly (e.g., via Bluetooth Classic® or a different short-range communication protocol) and/or indirectly (e.g., via the network 118). In some embodiments, the EVSE 106 and the EVSE 108 communicate with each other directly (e.g., via Bluetooth Classic® or a different short-range communication protocol) and/or indirectly (e.g., via the network 118, the satellite 120, the base station 122, and so forth). It is to be understood that the EV 102, EV 104, the EVSE 106, the EVSE 108, the network 118, the satellite 120, the base station 122, and other elements in the system 100 that may not be explicitly illustrated in FIG. 1 include appropriate wired and/or wireless interfaces to accommodate the abovementioned communication protocols and/or standards. Next, the description partly focuses on factors that affect a power load capacity at a certain EVSE.

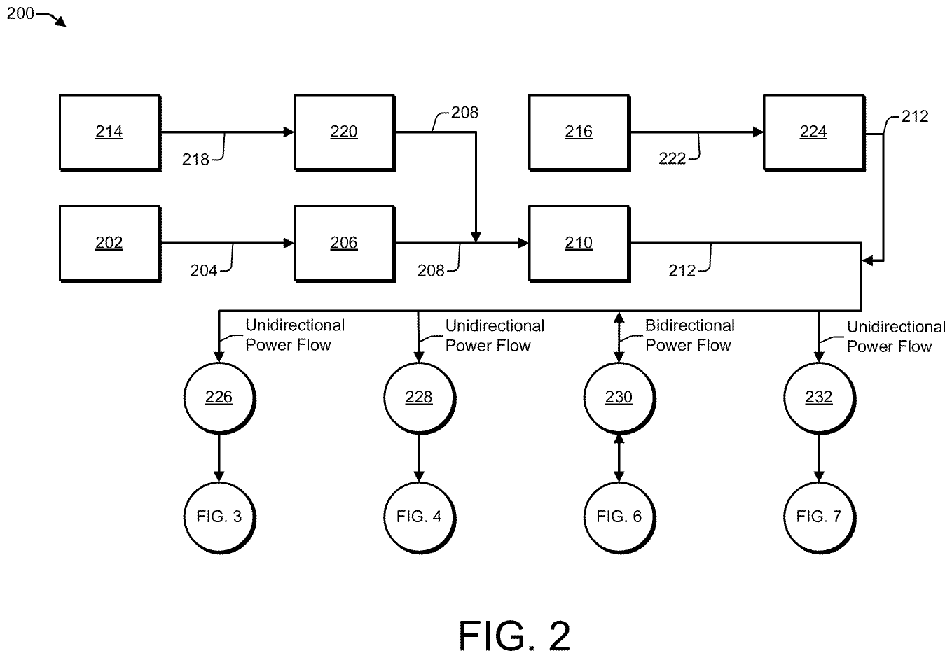

FIG. 2 illustrates a diagram of an example power grid 200, according to one embodiment. The power grid 200 may be a local (e.g., county, city) power grid, a regional (e.g., Southern Idaho) power grid, a state-wide (e.g., Utah) power grid, a country-wide (e.g., the United States of America) power grid, a continent-wide (e.g., Continental Europe, North America) power grid, and/or so forth. In some embodiments, the power grid 200 may be privately owned (e.g., a privately owned company, a privately owned corporation, a publicly traded corporation), government owned, privately owned and government regulated, government owned and internationally regulated, privately owned and internationally regulated, and/or a combination thereof. In some embodiments, the regulations may include voltage(s), current(s), phase(s), frequency(ies), grid protection, system protection, electric energy rates (e.g., cost), equipment protection, power industry employee protection, consumer protection, environmental protection, and/or other regulations defined by local, regional, country, international, power industry, and/or other entities. In some embodiments, the regulations may include an amount of a power generation capacity, energy trading, and/or an amount of power consumption (e.g., power demand, power load capacity).

Continuing with the power grid 200, a utility company may purchase (e.g., in an energy marketplace) and/or generate electric energy using at least one power plant(s) 202 (power plant 202). The power plant 202 may be centralized (e.g., in a particular location), decentralized in various locations, and may utilize renewable and/or nonrenewable energy sources to produce electric energy. The power plant 202 may generate a first electric power 204 (electric power 204). The utility company may then utilize at least one first transformer(s) 206 (transformer 206) to transform the electric power 204 to a second electric power 208 (electric power 208). The electric power 208 may have an accompanying set of characteristics, such as an AC power with three phases that is transmitted using a high voltage line and/or an extremely-high voltage line (e.g., for voltages 50,000 V to 200,000 V), and/or other characteristics. In some embodiments, the electric power 208 may be part of a transmission network (not explicitly illustrated in FIG. 2). The transmission network may be regulated by local, regional, country, international, power industry, and/or other entities. It is to be understood, however, that for the high voltage lines and/or the extremely-high voltage lines, some regulations may allow transmission of an AC power, a DC power, and/or a combination thereof that may be referred to as “hybrid” power. In some embodiments, the power grid 200 uses the electric power 208 for transmitting electric power over a first range of distances, for example, from a country to another country, from a state to another second state, from a region to another second region, from a city to another city, and/or so forth.

In some embodiments, the power grid 200 may also include at least one second transformer(s) 210 (transformer 210) to transform the electric power 208 to a third electric power 212 (electric power 212). The electric power 212 may have another accompanying set of characteristics, such as an AC power with three phases transmitted using a medium voltage line (e.g., for voltages 1,000 V to 50,000 V) and/or other power characteristics. In some embodiments, the electric power 212 may be part of a distribution network (not explicitly illustrated in FIG. 2). For example, the distribution network may provide the electric power 212 to a small country, a small principality, a small city-state, a small state, a county, a municipality, a city, a town, a village, a neighborhood, and/or so forth.

Given that the baseload of the power grid 200 may change over a duration of time, for example, one day, one week, one month, one year, and/or so forth, the utility company may also utilize a first peaking power plant(s) 214 (peaking power plant 214) and/or a second peaking power plant(s) 216 (peaking power plant 216) during a high power consumption, a high power demand, a high power load, and/or a peak power load. For example, the high power load may be during a particular time duration or period of a weekday, such as Monday through Friday from 7:00 AM to 9:00 AM, when some residents get ready for work; Monday through Friday from 5:00 PM to 7:00 PM, when some residents come back from work; and/or so forth. As another example, the high power load may be during a certain period of a year, for example, at the end of July, when some farmers may increase the use of water pumps to water their crops and/or so forth.

In some embodiments, the peaking power plant 214 may generate a fourth electric power 218 (electric power 218). The utility company may then use at least one third transformer(s) 220 (transformer 220) to transform the electric power 218 to the electric power 208. Therefore, the power grid 200 may utilize the peaking power plant 214 to supply electric power to the transmission network.

In some embodiments, the peaking power plant 216 may generate a fifth electric power 222 (electric power 222). The utility company may then use at least one fourth transformer(s) 224 (transformer 224) to transform the electric power 222 to the electric power 212. Therefore, the power grid 200 may utilize the peaking power plant 216 to supply electric power to the distribution network.

Although not illustrated in FIG. 2, the distribution network of the power grid 200 may also include other transformers to transform the electric power 212 to other electric powers having, for example, lower voltages, and/or sometimes fewer phases (e.g., two phases, one phase) to supply electric power to various establishments. The various establishments may include public EVSEs (e.g., public and/or private charging stations), residential homes, apartment complexes, offices, stores, educational institutions, government buildings, factories, and/or so forth.

Generally, utility-scale generation, storage, transmission, and/or distribution of electric power may be referred to as FTM electric power (and/or FTM electric energy). Therefore, as is illustrated in FIG. 2, the electric power (e.g., 204, 208, 212, 218, 222) of the power grid 200 may be referred to as an FTM electric power. Energy rates of the FTM electric power may change depending on an amount of electric power used by an establishment during a time of a day, a day of a week, a month of a year, and/or any combination thereof. For example, an establishment may pay a first energy rate for a first amount of the FTM electric power (e.g., the first 400 kWh), a second energy rate for a second amount of the FTM electric power (e.g., 400 kWh to 800 kWh), and/or a third energy rate for a third amount of the FTM electric power (e.g., over 800 kWh), wherein the third energy rate may be higher than the second energy rate, and the second energy rate may be higher than the first energy rate. As another example, an establishment may pay a fourth energy rate of the FTM electric power during non-peak power load hours (e.g., at 11:00 AM) and a fifth energy rate of the FTM electric power during peak power load hours (e.g., 7:00 AM to 9:00 AM, 5:00 PM to 7:00 PM), wherein the fifth energy rate may be higher than the fourth energy rate. As yet another example, an establishment may pay a sixth energy rate of the FTM electric power during a month of a year (e.g., March) and a seventh energy rate of the FTM electric power during another month of the year (e.g., July), wherein the seventh energy rate may be higher than the sixth energy rate.

Fortunately, the various establishments, including the public and/or private charging stations (charging stations), are increasingly utilizing renewable energy sources to generate electric energy. However, the charging stations may also utilize nonrenewable energy sources (e.g., fossil fuels) to generate electric energy, for example, for backup generation in cases of blackouts, brownouts, and/or staying “off the grid.” The electric energy and/or electric power generated by the charging stations may be referred to as BTM electric power (and/or BTM electric energy).

In aspects, BTM resources (e.g., solar panels, on-site batteries) may be distributed energy resources (DERs). In addition to the charging stations, the BTM resources may provide numerous benefits to communities and other establishments because they may help provide alternative means to using peaking power plants. Specifically, the peaking power plants 214 and 216 may be costly to operate, and the utility company may transfer operating costs to establishments with BTM resources and/or without BTM resources. Therefore, even establishments without BTM resources may benefit from less usage of the peaking power plants 214 and 216.

In one embodiment, the power grid 200 may partly support a decentralized system of generating and/or transferring electric power, whether the electric power is an FTM electric power and/or a BTM electric power. However, sustaining a stable power grid (e.g., without blackouts and/or brownouts) poses some challenges. One of many challenges may include storing a decentralized energy. In some embodiments, the decentralized energy may be stored in various forms, including chemically, potentially, gravitationally, electrically, thermally, and/or kinetically. For example, the charging stations may use batteries (e.g., lithium-ion batteries) to store electric energy (electric charge) generated during the daytime using solar panels. EVs (e.g., EVs 102 and 104) can then use the stored energy in the batteries of the charging stations during nighttime, peak power load hours, and/or whenever necessary.

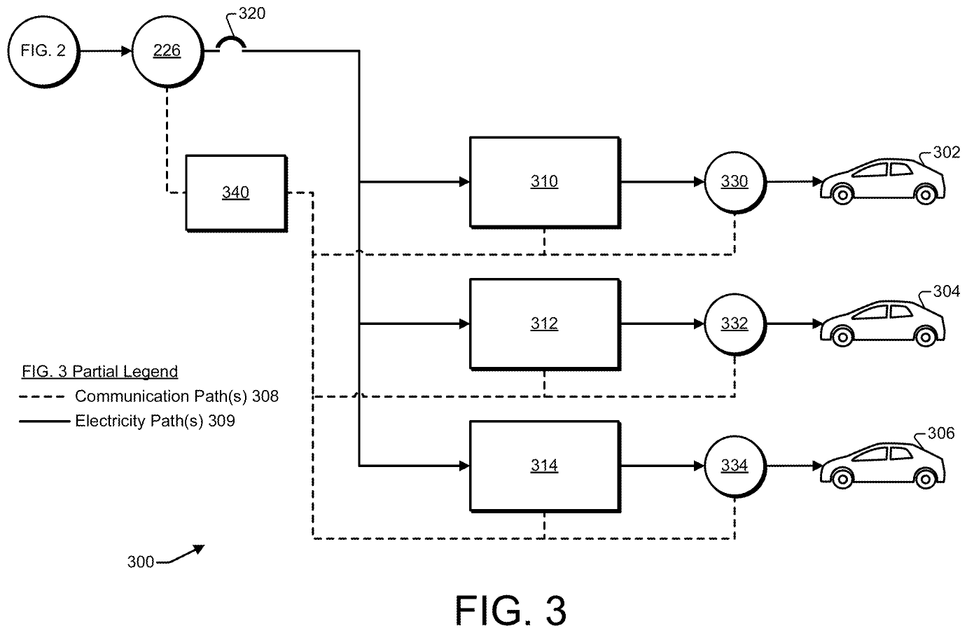

In one embodiment, the power grid 200 delivers AC power to an example first establishment and measures the delivered AC power using a first utility-side power meter 226 (power meter 226), where the example first establishment is further illustrated in FIG. 3.

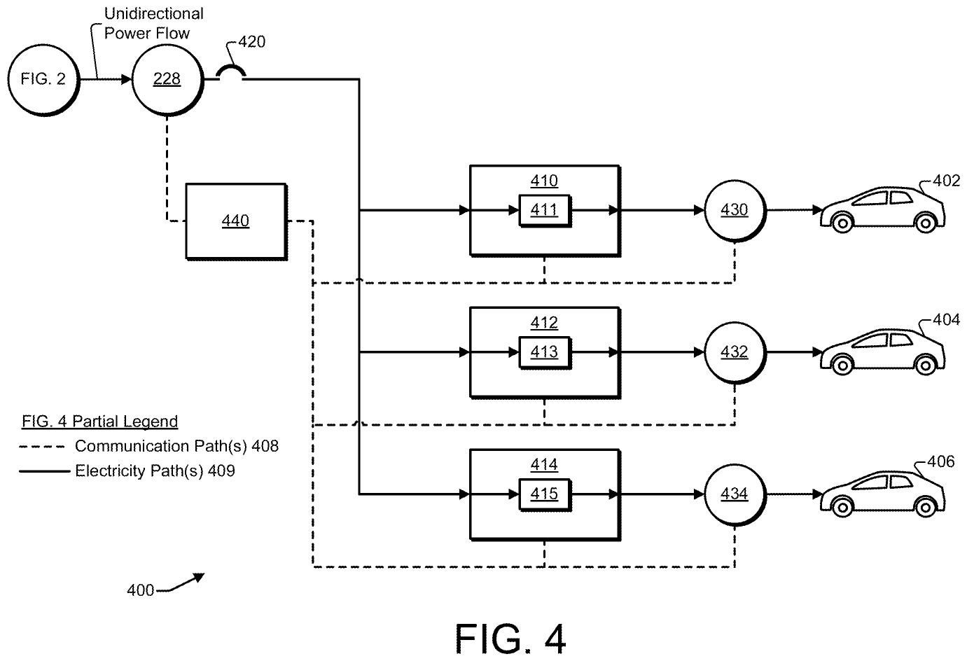

In one embodiment, the power grid 200 delivers AC power to an example second establishment and measures the delivered AC power using a second utility-side power meter 228 (power meter 228), where the example second establishment is further illustrated in FIG. 4.

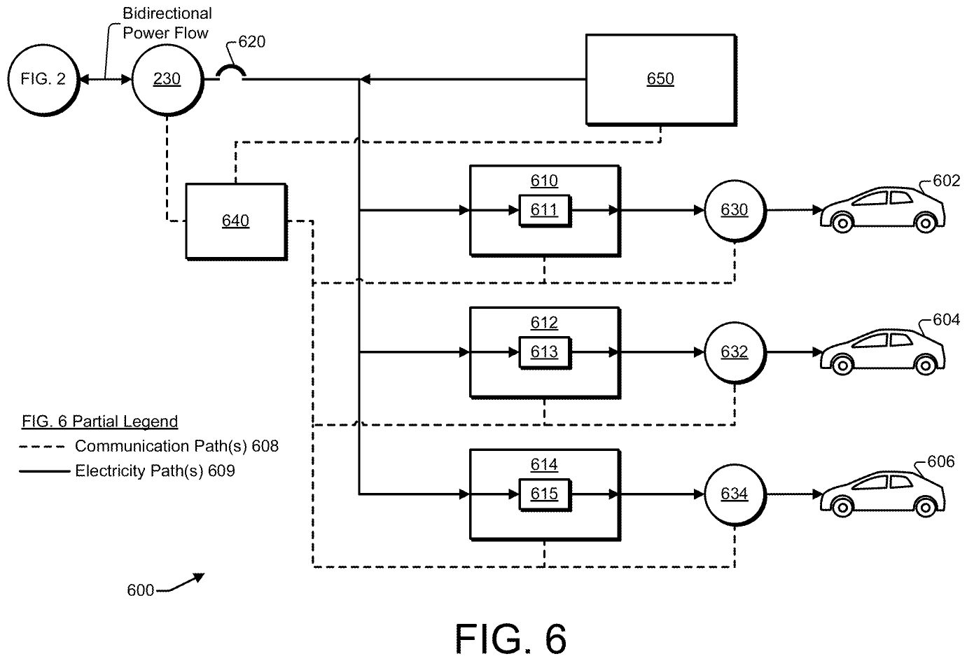

In one embodiment, the power grid 200 delivers AC power to an example third establishment and measures the delivered AC power using a third utility-side power meter 230 (power meter 230), where the example third establishment is further illustrated in FIG. 6. As it will become apparent from the description of FIG. 6, the example third establishment of FIG. 6 includes BTM resources. Therefore, power flow to and from the example third establishment can be bidirectional.

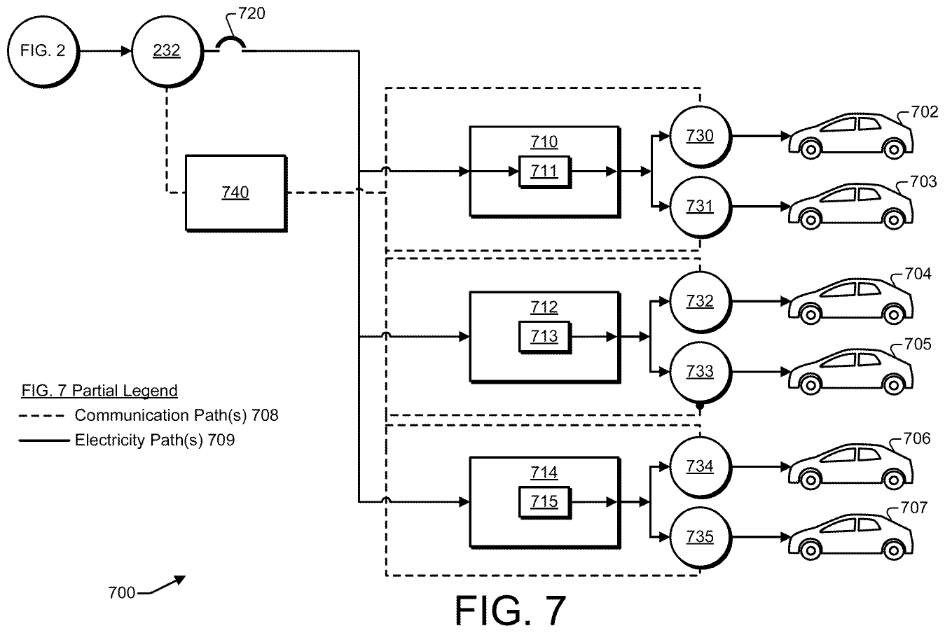

In one embodiment, the power grid 200 delivers AC power to an example fourth establishment and measures the delivered AC power using a fourth utility-side power meter 232 (power meter 232), where the example fourth establishment is further illustrated in FIG. 7.

In one embodiment, the power meters 226, 228, 230, and 232 may measure and/or monitor an AC power, an AC voltage, an AC current, a frequency (f), power harmonics, and/or other parameters of the AC power being delivered to and/or received from the example establishments.

In one embodiment, a utility company may own and/or operate the power meters 226, 228, 230, and 232. Nevertheless, in one aspect, the power meters 226, 228, 230, and 232 may define a separation (e.g., an abstract electric power border) of the power grid 200 from the example various establishments, and the FTM electric power from the BTM electric power. Next, the description partly focuses on AC charging stations, for example, Level 2 EVSEs.

FIG. 3 illustrates an example system 300 having a plurality of AC charging stations that are utilized for charging a plurality of EVs, according to one embodiment. The EVs may include a first EV 302 (EV 302), a second EV 304 (EV 304), a third EV 306 (EV 306), additional EVs (not illustrated in FIG. 3), or fewer EVs (e.g., only EV 302 and EV 304). To enable simultaneous charging of the EVs, the system 300 may include a plurality of EVSEs. In FIG. 3, the EVSEs are described as AC charging stations, for example, Level 2 EVSEs. The system 300 may include a first Level 2 EVSE 310 (EVSE 310), a second Level 2 EVSE 312 (EVSE 312), a third Level 2 EVSE 314 (EVSE 314), additional Level 2 EVSEs (not illustrated in FIG. 3), or fewer Level 2 EVSEs (e.g., only EVSE 310 and EVSE 312). The EVSE 310 may supply AC power to the EV 302; the EVSE 312 may supply AC power to the EV 304; and the EVSE 314 may supply AC power to the EV 306. In FIG. 3, communication signals (or communication path(s) 308) are illustrated with dashed lines, and flow of power and/or current (or electricity path(s) 309) is illustrated with solid lines.

FIG. 3 is illustrated and described in the context of FIGS. 1 and 2. When describing the system 300 in the context of FIG. 2, the system 300 may be coupled to the power meter 226 of FIG. 2, and the system 300 may receive AC power from the power grid 200 of FIG. 2. The system 300 may be decoupled from the power grid 200 using, for example, a circuit breaker 320. Alternatively, or additionally, a system (e.g., the system 300) may utilize at least one switch, at least one fuse, and/or any other means that can limit an amount of current and can selectively enable or disable flow of AC current and/or AC power from the power grid 200 to the system (e.g., the system 300) automatically, manually, and/or using a control system utilizing, for example, a supervisory control and data acquisition (SCADA) system.

Further, although not illustrated as such in FIG. 3 or in any other figure of this disclosure, in addition to a circuit breaker (e.g., the circuit breaker 320), a system (e.g., the system 300) may also include individual circuit breakers for each EVSE (e.g., the EVSEs 310, 312, and 314), enabling operators and/or engineers of the system to selectively decouple one, more than one, and/or all of the EVSEs in the system from a power grid (e.g., the power grid 200). Similarly, the operators and/or engineers of any of the systems described herein, can selectively and safely energize or de-energize one, more than one, and/or all electrical components in any of the systems described herein.

In some embodiments, the EVSE 310 may be coupled to a first user-side power meter 330 (power meter 330); the EVSE 312 may be coupled to a second user-side power meter 332 (power meter 332); and the EVSE 314 may be coupled to a third user-side power meter 334 (power meter 334), as is illustrated in FIG. 3. For at least business purposes, the power meters 330, 332, and 334 measure amounts of power (e.g., p_{AC}) being delivered to the EVs 302, 304, and 306, respectively. Therefore, users (e.g., drivers, passengers, and/or customers of electrical power) of the EVs may see in real time or near real time an amount of power being delivered to their EVs and may also see a cost of the amount of power being delivered to their EVs. The power meters 330, 332, and 334 may also measure and/or monitor a voltage, a current, a frequency, power harmonics, and/or other parameters of the AC power being delivered to the EVs 302, 304, and 306. In addition to measuring and/or monitoring the various parameters of the AC power being delivered to the EVs, the power meters 330, 332, and 334 may also be used to enhance user safety and/or reduce and/or prevent damages to the onboard AC-to-DC converter of the EV, the battery of the EV, and/or any other components of the EV. For example, the power meters 330, 332, and 334 may be utilized to limit an amount of current (e.g., AC current, i_{AC}) being delivered to the EVs 302, 304, and 306, respectively.

In some embodiments, the system 300 also may also include at least one controller 340. The controller 340 may be similar or equivalent to the system computing device 116 of FIG. 1. As such, the controller 340 may include at least one processor and at least one computer-readable medium, where the computer-readable medium does not include transitory propagating signals or carrier waves. The processor of the controller 340 may execute instructions (e.g., code, pseudocode, algorithms, application software) that may be stored in the computer-readable medium of the controller 340.

In some embodiments, the controller 340 may communicate with the power meters 226, 330, 332, and 334 and may receive measurements of the various parameters, including the power(s), the voltage(s), the current(s), the frequency(ies), the power harmonics, and/or so forth being measured and/or monitored by the meters 226, 330, 332, and 334. Although not explicitly illustrated in FIG. 3, in some embodiments, the controller 340 may also communicate with the circuit breaker 320 and/or with an associated electronic device (e.g., computing devices 110 and/or 112 of FIG. 1) of any of the EVs 302, 304, and 306, such as respective IVI systems of the EVs 302, 304, and 306. When communicating with the IVI systems of the EVs 302, 304, and 306, the controller 340 may receive EV-related data, such as a location of the EV, an SoC of the battery of the EV, and so forth. In addition to, or alternatively of, receiving the SoC from the respective IVI systems of the EVs 302, 304, and 306, the controller 340 may receive the SoC of the battery of the EV from measurements performed by the EVSEs 310, 312, and 314. In such a case, the controller 340 may communicate with the EVSEs 310, 312, and 314 to receive the SoCs of the batteries of the EVs 302, 304, and 306.

Like the system computing device 116 of FIG. 1, the controller 340 may communicate with the EVs 302, 304, and 306, the EVSEs 310, 312, and 314, and/or the power meters 226, 330, 332, and 334 directly, indirectly, with wired communication, and/or with wireless communication using a variety of communication standards and/or protocols, as described and illustrated in FIG. 1.

Unfortunately, operating EVSEs includes power losses. Nevertheless, when using AC charging stations, a sum of power readings of the user-side power meters (e.g., power meters 330, 332, and 334) approximately equals a power reading of an establishment-side (business-side) power meter (e.g., the power meter 226) because a power loss associated with the AC charging stations is nearly negligible. For example, control, processor, memory, and/or communication circuitry-related power loss(es) associated with, for example, the controller 340 and/or the system computing device 116 of FIG. 1, are nearly negligible compared to the AC power supplied to the EVs 302, 304, and 306.

Therefore, to balance and/or limit a power load of the system 300, the controller 340 and/or the system computing device 116 may selectively increase or decrease an output AC power of each of the EVSEs 310, 312, and 314, depending on charging needs of the EVs 302, 304, and 306. Further, the system 300 enables appropriately financially charging (e.g., a certain amount of money per kilowatt (kW), or per kilowatt-hour (kWh)) respective drivers of the EVs 302, 304, and 306, even when the drivers may simultaneously charge their EVs because an input AC power (p_{AC}) to each EVSE is approximately equal to an output AC power of each EVSE. Next, the description partly focuses on DC charging stations (or Level 3 EVSEs). The DC charging stations may include higher power losses compared to the AC charging stations.

FIG. 4 illustrates an example system 400 having a plurality of EVSEs that can charge a plurality of EVs, according to one embodiment. FIG. 4 builds on the description(s) and/or illustration(s) of FIG. 3. Unlike in FIG. 3, however, in FIG. 4, the EVSEs are described and illustrated as DC charging stations (or Level 3 EVSEs), instead of AC charging stations.

The EVs in FIG. 4 may include a first EV 402 (EV 402), a second EV 404 (EV 404), a third EV 406 (EV 406), additional EVs (not illustrated in FIG. 4), or fewer EVs (e.g., only EV 402 and EV 404). To enable simultaneous charging of the EVs, the system 400 may include a plurality of EVSEs. The system 400 may include a first Level 3 EVSE 410 (EVSE 410), a second Level 3 EVSE 412 (EVSE 412), a third Level 3 EVSE 414 (EVSE 414), additional Level 3 EVSEs (not illustrated in FIG. 4), or fewer Level 3 EVSEs (e.g., only EVSE 410 and EVSE 412).

The EVSE 410 may include a first on-site AC-to-DC converter 411 (AC-to-DC converter 411); the EVSE 412 may include a second on-site AC-to-DC converter 413 (AC to-DC converter 413); and the EVSE 414 may include a third on-site AC-to-DC converter 415 (AC-to-DC converter 415). In FIG. 4, from left to right, power preceding (or before entering) the AC-to-DC converters 411, 413, and 415 is input AC power (p_{AC}), and power succeeding (or leaving) the AC-to-DC converters 411, 413, and 415 is output DC power (P_{DC}). Therefore, the EVSE 410 (with the accompanying AC-to-DC converter 411) may supply an output DC power to the EV 402; the EVSE 410 may supply an output DC power to the EV 404; and the EVSE 412 may supply an output DC power to the EV 406. It is to be understood that the EVSEs 410, 412, and 414 may bypass the onboard AC-to-DC converters of the EVs 402, 404, and 406, respectively, and may charge respective batteries of the EVs 402, 404, and 406, directly.

In FIG. 4, communication signals (or communication path(s) 408) are illustrated with dashed lines. Flow of power and/or current (or electricity path(s) 409), regardless of an input AC power (p_{AC}), an input AC current (i_{AC}), an output DC power (P_{DC}), and/or an output DC current (I_{DC}), is and/or are illustrated with solid lines.

When describing the system 400 in the context of FIG. 2, the system 400 may be coupled to the power meter 228 of FIG. 2, and the system 400 may receive the input AC power from the power grid 200 of FIG. 2. The system 400 may be decoupled from the power grid 200 using, for example, a circuit breaker 420.

In some embodiments, the EVSE 410 may be coupled to a first user-side power meter 430 (power meter 430); the EVSE 412 may be coupled to a second user-side power meter 432 (power meter 432); and the EVSE 414 may be coupled to a third user-side power meter 434 (power meter 434). For at least business purposes, the power meters 430, 432, and 434 measure amounts of an electrical power (e.g., the output DC power, P_{DC}) being delivered to the EVs 402, 404, and 406, respectively. Therefore, users (e.g., drivers, passengers, and/or customers of electrical power) of the EVs may see in real time or in near real time the amount of the electrical power being delivered to their EVs and may also see a cost of the amount of the electrical power being delivered to their EVs.

The power meters 430, 432, and 434 may also measure and/or monitor a voltage (e.g., an output DC voltage, V_{DC}), a current (e.g., an output DC current, I_{DC}), and/or other parameters of the output DC power (P_{DC}) being delivered to the EVs 402, 404, and 406. In addition to measuring and/or monitoring the various parameters of the output DC power (P_{DC}) being delivered to the EVs, the power meters 430, 432, and 434 may also be used to enhance user safety and/or reduce and/or prevent damages to the batteries of the EVs, and/or any other component of the EVs. For example, the power meters 430, 432, and 434 may be utilized to limit an amount of current (e.g., output DC current, I_{DC}) and/or an amount of an electrical power (e.g., output DC power, P_{DC}) being delivered to the EVs 402, 404, and 406, respectively.

In some embodiments, the system 400 may also include at least one controller 440. The controller 440 of FIG. 4 may be the same, similar to, and/or equivalent to the system computing device 116 of FIG. 1. As such, the controller 440 may include at least one processor and at least one computer-readable medium, where the computer-readable medium does not include transitory propagating signals or carrier waves. The processor of the controller 440 may execute instructions (e.g., code, pseudocode, algorithms, application software) that may be stored in the computer-readable medium of the controller 440.

In some embodiments, the controller 440 (and/or the system computing device 116) may communicate with the power meters 430, 432, and 434 and may receive measurements of the various parameters, including the P_{DC} being delivered to each EV, the output DC voltage (V_{DC}) being used to charge each EV, and/or the output DC current (I_{DC}) being delivered to each EV. The controller 440 may also communicate with the power meter 228 and may receive measurements of the various parameters, including an AC power that the power grid 200 of FIG. 2 delivers to the system 400 of FIG. 4, an input AC voltage, an input AC current, a frequency of the input AC power, power harmonics of the input AC power, and/or other parameters being measured and/or monitored by the power meter 228.

Although not explicitly illustrated in FIG. 4, in some embodiments, the controller 440 and/or the system computing device 116 may also communicate with the circuit breaker 420 and/or with an associated electronic device (e.g., computing devices 110 and/or 112 of FIG. 1) of any of the EVs 402, 404, and 406, such as respective IVI systems of the EVs 402, 404, and 406. When communicating with the IVI systems of the EVs 402, 404, and 406, the controller 440 and/or the system computing device 116 may receive EV-related data (EV characteristics), such as respective locations of the EVs 402, 404, and 406, respective SoCs of the EVs, and so forth. In addition to, or alternatively of, receiving the SoCs from the IVI systems, the controller 440 and/or the system computing device 116 may receive the SoCs from measurements performed by respective EVSEs (e.g., EVSEs 410, 412, and 414). In such a case, the controller 440 and/or the system computing device 116 may communicate with the EVSEs 410, 412, and 414 to receive the SoCs, as is illustrated by, for example, the communication path(s) 408 in FIG. 4 (dashed lines, as shown in a partial legend of FIG. 4).

The system computing device 116 of FIG. 1 and/or the controller 440 of FIG. 4 may communicate with the EVs 402, 404, and 406, the EVSEs 410, 412, and 414, and/or the power meters 228, 430, 432, and 434 directly, indirectly, with wired communication, and/or with wireless communication by using a variety of communication standards and/or protocols, as is described in FIG. 1.

Unfortunately, operating the EVSEs 410, 412, and 414 includes power losses, adversely affecting a power conversion efficiency(ies) of the EVSEs. The power losses associated with the Level 3 DC charging stations (e.g., EVSEs 410, 412, and 414 of FIG. 4) may be considerably greater than the power losses associated with the AC charging stations (e.g., EVSEs 310, 312, and 314 of FIG. 3), partly because of power losses associated with the on-site AC-to-DC converters 411, 413, and 415 and the associated circuitry of the on-site AC-to-DC converters. Further, the power losses of each of the EVSEs 410, 412, and/or 414 may not be equal, partly depending on SoCs of respective batteries of the EVs 402, 404, and 406.

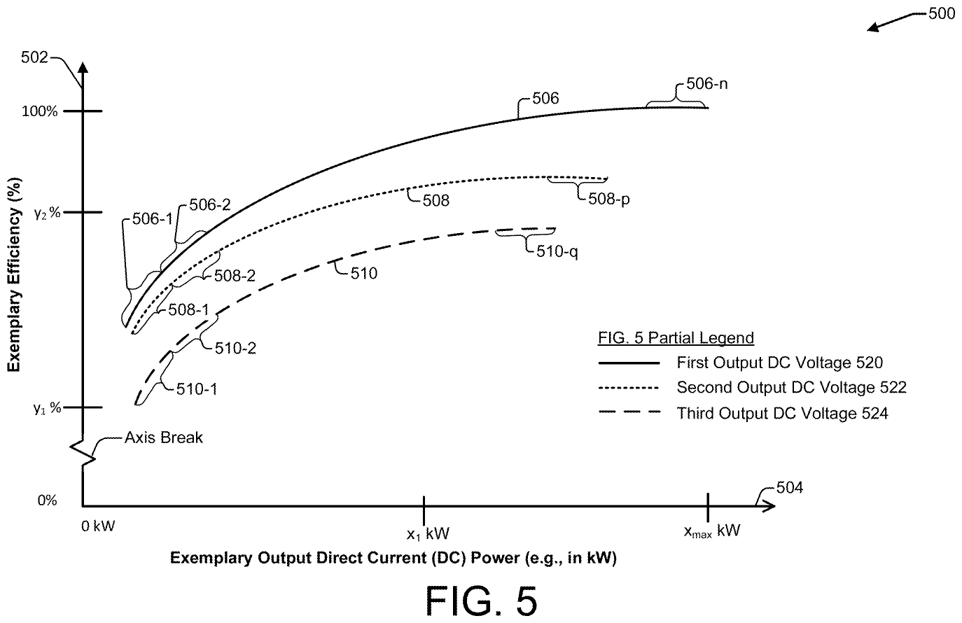

For example, if:
the EVSE 410 supplies DC power to the battery of the EV 402, and the battery of the EV 402 has an SoC of approximately 90%;
the EVSE 412 supplies DC power to the battery of the EV 404, and the battery of the EV 404 has an SoC of approximately 50%; and
the EVSE 414 supplies DC power to the battery of the EV 406, and the battery of the EV 406 has an SoC of approximately 10%; then:
a first power conversion efficiency of the EVSE 410 may be greater than a second power conversion efficiency of the EVSE 412; and
the second power conversion efficiency of the EVSE 412 may be greater than a third power conversion efficiency of the EVSE 414, as is further described below, for example, in relation to FIG. 5.

Consequently, unlike the case of the AC charging stations of FIG. 3, in FIG. 4, a sum of power readings of the user-side power meters (e.g., power meters 430, 432, and 434) may not equal a power reading of a utility-side power meter (e.g., the power meter 228) because power losses associated with the DC charging stations (e.g., EVSEs 410, 412, and 414) may not be negligible and/or may differ from an EVSE to another EVSE. Consequently, in one embodiment, without proper accounting of the power losses associated with each EVSE, an establishment (e.g., a public charging station) may be unable to balance, optimize, and/or increase an overall power conversion efficiency of all the EVSEs (e.g., EVSEs 410, 412, and 414), for example, by increasing or decreasing an output DC power and/or an output DC current of each EVSE in the system. The establishments (e.g., the system 400) described herein, however, can properly account for the power losses of each EVSE. For example, the controller 440 and/or the system computing device 116 can enable the system to balance a power load associated with each EVSE, each EV, and/or an overall power load of the system.

Further, the system 400 may selectively transfer financial costs to a respective driver of an EV with a low SoC of the battery of the EV, due to a decreased power conversion efficiency of the EVSE supplying an output DC power to the EV with the low SoC. By so doing, the system 400 may accurately financially charge (e.g., $ per kW, or $ per kWh) respective drivers of the EVs. Thus, in one aspect, the system 400 may incentivize drivers to minimize times (occurrences) the driver of the EV nearly depletes the battery of the EV. It may behoove the driver of the EV to charge their EVs more often to potentially pay a lower energy rate (e.g., $ per kW, or $ per kWh) to charge their EV, increase an efficiency of AC to DC power conversion (or power transfer), and/or increase other benefits associated with the increased efficiency of the AC to DC power conversion (or power transfer).

In some embodiments (not illustrated as such in FIG. 4 or in any other FIG.), in addition to the utility-side and user-side power meters, engineers may install additional power meters after the utility-side power meter (e.g., power meter 228) and before each EVSE. The additional power meters may be utilized to calculate and account for the power losses associated with the each EVSE, by subtracting power readings and/or measurements from each respective user-side power meter (e.g., power meters 430, 432, and 434). Such a solution, however, includes additional equipment (e.g., additional power meters), additional space, additional installation costs, retrofitting costs, and/or operational costs, including periodic fees (e.g., monthly connectivity fees to a cloud and/or server) to maintain and operate each additional power meter.

To reduce a count of additional equipment and their associated costs, the system 400 may utilize the controller 440 and/or the computing devices 110, 112, and/or 116 to determine power losses associated with the EVSEs (e.g., EVSEs 410, 412, and 414). Specifically, the controller 440 and/or the system computing device 116 may calculate power conversion efficiencies of the EVSEs 410, 412, and 414 by, for example, utilizing measurements from the power meters 430, 432, 434, and/or 228, without utilizing additional power meters preceding each EVSE of the plurality of the EVSEs, as is further described below, partly in relation to FIG. 5.

FIG. 5 shows an example graph 500 of illustrative power conversion efficiency curves (efficiency curves) of a plurality of EVSEs (e.g., EVSEs 410, 412, and 414 of FIG. 4), according to one embodiment. In one aspect, the efficiency curves may represent power conversion efficiency profiles of the EVSEs, where the EVSEs may supply power to a plurality of EVs (e.g., EVs 402, 404, and 406).

FIG. 5 is described in the context of FIGS. 1, 2, and 4. FIG. 5 is not described in the context of FIG. 3. Therefore, the illustrative power conversion efficiency curves are described in the context of DC charging stations (or Level 3 EVSEs). FIG. 5 does not represent real measurements, actual efficiency curves, actual power conversion efficiencies, and/or actual power conversion efficiency profiles of the DC charging stations. Also, differences in the illustrated efficiency curves of the DC charging stations may be exaggerated. Therefore, FIG. 5 is disclosed for illustration purposes only and to better explain a relation between the SoC of the battery of the EV and the power conversion efficiency of the EVSE that supplies DC power to the EV.

Specifically, FIG. 5 illustrates relations of exemplary percent efficiency(ies) 502 (e.g., from 0% to 100%, or from zero (0) to one (1), inclusive) of a first, a second, and a third EVSE versus an output DC power(s) 504 (e.g., in kW) of the first, second, and third EVSE. In percent, a lowest power conversion efficiency of any EVSE of the system (e.g., system 400) may be y₁% (e.g., 85, 90, 95, 96%, and/or so forth). In kW, a lowest output DC power 504 may be zero (0) kW, and a highest output DC power of the any EVSE of the system may be approximately xₘₐₓ kW (e.g., 75, 80, 100 kW, and/or so forth). The power conversion efficiency of an EVSE (a DC charging station) may depend on the input AC voltage (v_{AC}), an output DC voltage (V_{DC}), and/or an output DC current (I_{DC}). Since often the input AC voltage is partly and/or entirely maintained and/or regulated by the power grid (e.g., a utility company, the power grid 200 of FIG. 2), the system with the EVSEs may have limited and/or no control on the input AC voltage (v_{AC}). Thus, FIG. 5 is illustrated in a context of a relatively constant input AC voltage(s).

For example, an establishment with a plurality of DC charging stations (e.g., the system 400 of FIG. 4) may be coupled to an electrical service (e.g., 480 v_{AC}, not illustrated) of the power grid (e.g., the power grid 200 of FIG. 2) via, for example, a circuit breaker (e.g., the circuit breaker 420 of FIG. 4). Further, FIGS. 1, 4, 5 and/or any other figure in this disclosure assumes no voltage drop and/or an equal voltage drop(s) from the power grid 200, the utility-side power meters, the electrical service(s), and/or the circuit breaker(s) (e.g., circuit breaker 420 of FIG. 4) to each EVSE of the plurality of the EVSEs. To this end, the input AC voltage to each EVSE is the same, for example, approximately 480 v_{AC}. Furthermore, the system (e.g., the system 400) that includes DC charging stations may not selectively vary the output DC voltage (V_{DC}) while charging an EV, partly because the output DC voltage of the DC charging station may be approximately equal to and/or may be dependent on the DC voltage of the battery of the EV. Additionally, the DC voltage of the battery of the EV may vary with an SoC of the battery. For example, a higher SoC of the battery may result in a higher voltage of the battery of the EV. Consequently, in some embodiments, the system with the DC charging stations may not selectively vary the input AC voltage (v_{AC}) or the output DC voltage (V_{DC}) of the DC charging stations.

Nevertheless, in some embodiments, the controller (e.g., the controller 440 of FIG. 4) and/or the system computing device 116 of FIG. 1 can enable the system (e.g., the system 400 of FIG. 4) with the DC charging stations (e.g., EVSEs 410, 412, and 414 of FIG. 4) to selectively vary the input AC current (i_{AC}) and/or the input AC power (p_{AC}) to one, more than one, and/or all of the DC charging stations. The controller and/or the system computing device 116 can also enable the system to selectively vary (e.g., increase or decrease) the output DC current (I_{DC}) and/or the output DC power (P_{DC}) of one, more than one, and/or all of the DC charging stations. By so doing, the controller and/or the system computing device 116 can enable the system to vary the power conversion efficiencies of, and/or the power losses associated with, the DC charging stations.

In detail, for illustration purposes only, the graph 500 shows a first example power conversion efficiency curve 506 (efficiency curve 506) of the first EVSE (e.g., a first DC charging station, the EVSE 410 of FIG. 4). The first EVSE may supply a first output DC power (e.g., in kW) to a first battery of a first EV (e.g., EV 402), and the first battery may have a first SoC (e.g., approximately 90%). In such a case, a first output DC voltage 520 (output DC voltage 520) of the first EVSE may be approximately equal to and/or may be dependent on a first DC voltage of the first battery. For example, the first DC voltage of the first battery may be directly (instead of inversely) related to the first SoC. In the graph 500, the output DC voltage 520 may be considerably close to an upper threshold output DC voltage.

Similarly, for illustration purposes only, the graph 500 shows a second example power conversion efficiency curve 508 (efficiency curve 508) of the second EVSE (e.g., a second DC charging station, the EVSE 412 of FIG. 4). The second EVSE may supply a second output DC power to a second battery of a second EV, and the second battery may have a second SoC (e.g., approximately 50%). In such a case, a second output DC voltage 522 (output DC voltage 522) of the second EVSE may be approximately equal to, and/or may be dependent on, a second DC voltage of the second battery of the second EV. For example, the second DC voltage of the second battery may be directly (instead of inversely) related to the second SoC. In the graph 500, the output DC voltage 522 may be considerably close to a medium threshold output DC voltage.

Finally, for illustration purposes only, the graph 500 shows a third example power conversion efficiency curve 510 (efficiency curve 510) of the third EVSE (e.g., a third DC charging station, the EVSE 414 of FIG. 4). The third EVSE may supply a third output DC power (e.g., in kW) to a third battery of a third EV (e.g., EV 406), and the third battery may have a third SoC (e.g., approximately 10%). In such a case, a third output DC voltage 524 (output DC voltage 524) of the third EVSE may be approximately equal to, and/or may be dependent on, a third DC voltage of the third battery. For example, the third DC voltage of the third battery may be directly (instead of inversely) related to the third SoC. In the graph 500, the output DC voltage 524 may be considerably close to a lower threshold output DC voltage.

In one aspect, the controller (e.g., the controller 440 of FIG. 4) and/or the system computing device 116 of FIG. 1 may utilize the efficiency curves 506, 508, and/or 510 to calculate power losses associated with the first, second, and/or third EVSE. In another aspect, although limited by the efficiency curves 506, 508, and/or 510, the controller and/or the system computing device 116 can and/or may enable the system to selectively vary the power conversion efficiency of one, more than one, and all of the EVSEs by, for example, varying respective output DC current(s) and/or output DC power(s) of the EVSE(s). In yet other aspects, the efficiency curves may account for charging preferences of a customer(s) (e.g., a driver of an EV, drivers of a fleet of EVs), such as: a target SoC (e.g., 50%, 80%, 90%, full charge), by when the drivers need their EVs to be ready to drive, a target electricity rate (e.g., cost, $ per kWh, $ per kW), and/or so forth. As is illustrated by the graph 500, a power conversion efficiency of an EVSE increases with a higher output DC current and/or a higher output DC power.

Each DC charging station (e.g., EVSEs 410, 412, and 414), however, includes an upper threshold output DC current and/or an upper threshold output DC power. For example, the upper threshold output DC current may be limited by an electrical circuit (e.g., a charging cable), may be an industry standard, may be set by designers and/or engineers, and/or so forth. As another example, the upper threshold output DC power may be limited by an upper threshold input AC power, for example, a power availability (e.g., baseload power) at the distribution line of the power grid 200 of FIG. 2, a count of EVs simultaneously charging at a system (e.g., the system 400) with the plurality of the EVSEs, respective SoCs, and/or so forth.

In some embodiments, the controller (e.g., the controller 440 of FIG. 4) and/or the system computing device 116 of FIG. 1 can selectively enable the system to change a power load of the system, by changing a power load of one, more than one, and/or all the EVSEs. The selective change of the power load of the system may be referred to as a “power demand response,” or a “demand response.” The demand response may be driven by a “frequency regulation” of the power grid 200 at, for example, a certain power grid, a certain location, a certain transmission line, a certain distribution line, a certain electrical service, and/or so forth. For example, in the United States of America, a deviation from a 60 Hertz (Hz) frequency of the AC power may cause the power grid (e.g., the power grid 200) to become unstable. Generally, if a power generation is considerably greater than a power demand (power load), the frequency of the AC power may increase above the 60 Hz. Similarly, if the power generation is considerably less than the power demand, the frequency of the AC power may decrease below the 60 Hz. To this end, operators of the power grid 200 may employ the frequency regulation to prevent the frequency of the AC power rising considerably above or below the 60 Hz.

In some embodiments, the controller and/or the system computing device 116 can selectively enable the system to change the power load of the system to remain under a particular power demand threshold during a time of a day, a day of a week, a week of a month, a month of a year, and/or so forth. For example, going above the power demand threshold may increase energy rates (cost), cause blackouts, cause brownouts, increase the utilization of the peaking power plants, cause the frequency of the power grid to drop below the 60 Hz, and/or so forth. Furthermore, to better serve drivers of the EVs by providing more affordable output DC power, the controller and/or the system computing device 116 can selectively enable the system to adjust the power load of one, more than one, and/or all the EVSEs.

Moreover, to charge a plurality of EVs simultaneously, but still perform the power demand response, remain under the power demand threshold, and/or reduce, limit, and/or avoid high energy rates, the controller and/or the system computing device 116 can enable the system to selectively perform a load balancing of the plurality of the EVSEs and the associated EVs that are receiving charge. Initially, the controller (e.g., the controller 440) and/or the system computing device 116 may estimate power losses associated with each EVSE, where the EVSEs may simultaneously charge the EVs having different SoCs, as is further described below.

Continuing with FIGS. 4 and 5, in some embodiments, the controller (e.g., controller 440) and/or the system computing device 116 of FIG. 1 may store, utilize, and/or selectively execute a first-order efficiency approximation algorithm (an efficiency approximation algorithm). Since, normally, an electrical service (e.g., 480 v_{AC}) supplies a relatively constant input AC voltage to the system (e.g., the system 400), the efficiency approximation algorithm may set an input AC voltage parameter to a fixed input AC voltage. Alternatively, or additionally, the controller (e.g., the controller 440) and/or the system computing device 116 may communicate with the power meter 228 to receive and use a measurement of the input AC voltage to the system 400 and the EVSEs. For a given input AC voltage into the EVSE, and a given output DC voltage out of the EVSE, the efficiency approximation algorithm may then use a lower (or lowest) power conversion efficiency (flow) of the EVSE to calculate the power losses associated with the EVSE, as is shown in Equation 1.

$${p}_{A C} = \frac{{P}_{D C}}{{η}_{low}} \qquad Equation 1$$

In Equation 1, p_{AC} denotes the input AC power (e.g., true input AC power, real input AC power, active input AC power, average input AC power) to each EVSE (e.g., EVSE 410, 412, and/or 414); P_{DC} denotes the output DC power of each EVSE; and flow denotes a lower (or the lowest) power conversion efficiency for a given output DC voltage V_{DC} of each EVSE, where 0<η_{low}<1 (or 0%<η_{low}<100%). Next, the description partly focuses on additional, or alternative, techniques, methods, and/or algorithms that can increase the accuracy of the power loss calculations associated with each EVSE.

Continuing with FIGS. 4 and 5, in one embodiment, the controller (e.g., the controller 440 of FIG. 4) and/or the system computing device 116 of FIG. 1 may store, utilize, and/or selectively execute a real-time efficiency algorithm. The real-time efficiency algorithm may initially tabulate (e.g., arrange in a table) a majority of, or a set of all, points of and/or in the efficiency curve(s) 506, 508, or 510 of FIG. 5 of each EVSE (e.g., EVSEs 410, 412, and 414). As a respective EV receives charge from a respective EVSE, the output DC current (I_{DC}) and/or the output DC voltage (V_{DC}) of the EVSE may vary with time. Consequently, as the EV receives charge from the EVSE, the output DC power (P_{DC}) may vary with time. Then, for a given input AC voltage into the EVSE, the real-time efficiency algorithm may then use a real-time, an approximate, and/or an actual power conversion efficiency (ηᵣₑₐₗ₋ₜᵢₘₑ) of the EVSE to calculate the power losses associated with the EVSE, as is shown in Equation 2.

$${p}_{AC \_ real - time} = \frac{{P}_{DC \_ real - time}}{{η}_{real - time}} \qquad Equation 2$$

In Equation 2, p_{AC_real-time} denotes a real-time input AC power (e.g., true input AC power, real input AC power, active input AC power, average input AC power) to each EVSE; P_{DC_real-time} denotes a real-time output DC power of each EVSE; and ηᵣₑₐₗ₋ₜᵢₘₑ denotes the real-time power conversion efficiency for a real-time output DC voltage (V_{DC_real-time}) and a real-time output DC current (I_{DC_real-time}) of each EVSE, where 0<ηᵣₑₐₗ₋ₜᵢₘₑ<1 (or <0%<ηᵣₑₐₗ₋ₜᵢₘₑ<100%).

FIG. 5 illustrates only three example power conversion efficiency curves (e.g., efficiency curves 506, 508, and 510). However, at least theoretically, there may be an infinite number of efficiency curves, for example, between the efficiency curves 506 and 510, above the efficiency curve 510, and/or below the efficiency curve 506. Consequently, according to some embodiments, the efficiency curve of a DC charging station may change (e.g., increase) with time, as the battery of the EV receives more charge from the DC charging station. In such a case, the real-time efficiency algorithm may then tabulate another majority of, or another set of all, points of and/or in another efficiency curve. The real-time efficiency algorithm may then utilize the real-time power conversion efficiency (ηᵣₑₐₗ₋ₜᵢₘₑ) of the EVSE. The real-time efficiency algorithm may be a real-time iterative process. Consequently, the real-time efficiency algorithm may require considerable memory and/or computational resources.

Continuing with FIGS. 4 and 5, although the controller (e.g., the controller 440 of FIG. 4) and/or the system computing device 116 of FIG. 1 may selectively utilize the real-time efficiency algorithm, such a solution may not be necessary to efficiently, effectively, and/or accurately calculate power losses associated with each EVSE and/or to efficiently, effectively, and/or accurately allocate power between the EVSEs. For example, as the EV receives power from the EVSE, the SoC of the battery of the EV may not change (e.g., increase) by a considerable amount within a considerably short time period (or time interval), for example, within twenty milliseconds, within one second, within five seconds, and/or so forth. Consequently, the efficiency curve and/or the output DC voltage of the EVSE does not considerably change within the short time period (e.g., every second). As another example, the power demand (or power load) of the system (e.g., the system 400), the baseload power of the power grid 200, the frequency of the AC power of the power grid, and/or so forth do not considerably change within the short time period (e.g., every second). Therefore, it may not be required for the system (e.g., the system 400) to employ the demand response and/or the load balancing within the short time period (e.g., every second) and/or in real time.

To this end, in one embodiment, to reduce and/or conserve memory and/or computational resources, the controller (e.g., the controller 440 of FIG. 4) and/or the system computing device 116 of FIG. 1 may store, selectively utilize, and/or selectively execute a time-interval efficiency algorithm (e.g., every T minute(s), where T is a positive integer). For example, every T minutes, the controller and/or the system computing device 116, may communicate with the EV(s) to receive EV characteristics including the SoC of the battery of the EV. In addition, or alternatively, every T minutes, the controller and/or the system computing device 116 may communicate with each EVSE to receive the SoCs of each respective EV. As another example, every T minutes, the controller and/or the system computing device 116 may selectively utilize and/or execute the time-interval efficiency algorithm to calculate the power conversion efficiency of each EVSE, and subsequently, the power losses associated with each EVSE. As yet another example, every T minutes, the controller and/or the system computing device 116 may cause the system to perform the demand response and/or the load balancing.

In addition, or alternatively, in every T minutes, the controller and/or the system computing device 116 may measure, calculate, and/or verify the output DC voltage, the output DC current, and the output DC power of each EVSE. Based on the SoC of the battery of each EV, the output DC voltage, the output DC current, the output DC power, and the efficiency curve of each EVSE, the controller and/or the system computing device 116 may selectively utilize the interval-time efficiency algorithm to determine an approximate and/or actual time-interval power conversion efficiency (ηₜᵢₘₑ₋ᵢₙₜₑᵣᵥₐₗ) of each EVSE, for example, every T minutes, as is shown in Equation 3.

$${p}_{AC \_ time - interval} = \frac{{P}_{DC \_ time - interval}}{{η}_{time - interval}} \qquad Equation 3$$

In Equation 3, P_{AC_time-interval} denotes a time-interval input AC power (e.g., true input AC power, real input AC power, active input AC power, average input AC power) to each EVSE; P_{DC_time-interval} denotes a time-interval output DC power of each EVSE; and flume-interval denotes the time-interval power conversion efficiency for a time-interval output DC voltage (V_{DC}_time-interval) and for a time-interval output DC current (I_{DC_time-interval}) of each EVSE, where 0<ηₜᵢₘₑ₋ᵢₙₜₑᵣᵥₐₗ<1 (or <0%<ηₜᵢₘₑ₋ᵢₙₜₑᵣᵥₐₗ<100%).

For brevity and clarity, the following description partly focuses on and/or emphasizes the controller (e.g., the controller 440) and/or system computing device 116 storing, utilizing, and/or selectively executing the time-interval efficiency algorithm to determine and/or calculate the power conversion efficiencies of each EVSE in the system.

In one aspect, the controller 440 of FIG. 4 and/or the system computing device 116 of FIG. 1 may communicate with the EVs 402, 404, and 406 of FIG. 4, the EVSEs 410, 412, and 414 of FIG. 4, the power meters 430, 432, and 434 of FIG. 4, the power meter 228 of FIG. 2, and/or the database 114 using, for example, the communication path(s) 408 of FIG. 4, the communication path(s) 107 of FIG. 1, and/or other communication paths that are not explicitly illustrated. The communication may enable the controller 440 and/or the system computing device 116 to receive measurements of an output DC current (I_{DC}) and the output DC voltage (V_{DC}) of an EVSE. Then, the controller 440 and/or the system computing device 116 may use the power conversion efficiency curve of the EVSE to determine an output DC power (P_{DC}) of the EVSE. The system 100 of FIG. 1 and/or the system 400 of FIG. 4 may store the power conversion efficiency curves (e.g., efficiency curves 506, 508, and 510) in the controller (e.g., the controller 440), the system computing device 116, and/or the database 114. Additionally, the system 100 of FIG. 1 and/or the system 400 of FIG. 4 may also store energy rates (cost), the frequency regulation of the power grid 200, an available AC power (e.g., at the power meter 228 of FIG. 2), SoCs of the EVs, and/or other parameters.

In one aspect, due to limitations, such as: the frequency regulation; an available amount of AC power; an available amount of FTM power; an available amount of BTM power; a rating of the electrical service; a setting on the circuit breaker (e.g., the circuit breaker 420); high energy rates depending on the time of the day, the day of the week, the week of the month, the month of the year; and/or other factors, the system 100 and/or the system 400 may utilize the controller (e.g., the controller 440 of FIG. 4), and/or the system computing device 116 of FIG. 1 to limit an amount of the input AC power being delivered to the EVSEs.

Further, the system (e.g., the system 400) with the controller and/or the system computing device 116 may use the EV characteristics (e.g., SoC) to determine a relationship between a DC voltage of the battery of the EV, the output DC voltage of the EVSE charging the EV, and the power conversion efficiency of the EVSE. The controller and/or the system computing device 116 can enable the system to selectively vary the power conversion efficiency and/or the output DC power of each EVSE by varying the output DC current of the EVSE.

In one aspect, using the time-interval efficiency algorithm, the controller and/or the system computing device 116, based on the output DC voltage and the output DC current to the EVSE can determine and/or selectively enable the system to adjust the output DC power and/or the power conversion efficiency of the EVSE, without using considerable computational and/or memory resources. Continuing with FIG. 5, in one embodiment, after determining the SoC of the EV, the time-interval efficiency algorithm may express the relationship between the output DC voltages 520 to 524, efficiency curves 506 to 510, and the output DC powers of each EVSE as a piece-wise function(s). For example, a first piece-wise function may express the efficiency curve 506 as a first plurality of piece-wise efficiency curves 506-1, 506-2, . . . , 506-n, where n is a positive integer. Similarly, a second piece-wise function may express the efficiency curve 508 as a second plurality of piece-wise efficiency curves 508-1, 508-2, . . . , 508-p, where p is a positive integer. Similarly, a third piece-wise function may express the efficiency curve 510 as a third plurality of piece-wise efficiency curves 510-1, 510-2, . . . , 510-q, where q is a positive integer.

As is illustrated in FIG. 5, respective maxima power conversion efficiencies of each EVSE correspond to respective maxima output DC powers of the each EVSE. Therefore, if theoretically there were not limitations of the input AC power (the AC power from the power grid 200), the system (e.g., the system 400) may selectively configure the EVSEs to supply a maximum output DC power. However, as previously discussed, the system may include and/or may accommodate numerous constraints, including a limited amount of the input AC power. To this end, the time-interval efficiency algorithm may enable the system to selectively vary the efficiency curves based on, for example, the customer needs (e.g., SoCs), constraints of the power grid 200, energy costs, and/or other forementioned factors.

In one aspect, the time-interval efficiency algorithm may set and/or determine an efficiency threshold y₂% (e.g., 90%, 95%, and/or so forth) of the EVSEs, where each EVSE may not convert AC to DC power below the efficiency threshold y₂%. In another aspect, the time interval algorithm may set and/or determine an output DC power threshold x₁ kW (e.g., 25 kW, 30 kW, 45 kW, and/or so forth) of the EVSEs, where each of the EVSEs may not operate below the output DC power threshold x₁ kW. In yet another aspect, the time-interval algorithm may select different efficiency thresholds and different output DC power thresholds depending on the SoC of the EV.

In one aspect, the selection of the different efficiency thresholds and the different output DC power thresholds may enable the system to strike a balance between customer needs, power conversion efficiencies of each EVSE, power losses associated with each EVSE, the SoCs of the EVs, limitations on the amount of the input AC power, and/or other forementioned factors. Next, the description partly focuses on BTM resources.

FIG. 6 illustrates an example system 600 having a plurality of EVSEs that can charge a plurality of EVs, according to one embodiment. FIG. 6 is described in the context of FIGS. 1, 2, 4, and 5. FIG. 6 is not described in the context of FIG. 3. Specifically, the EVSEs of FIG. 6 are DC charging stations. Comparing items (or components) of FIG. 6 to items of FIG. 4, like items in FIG. 4 with numbers “4zz” are the same, similar to, and/or equivalent with like items in FIG. 6 with numbers “6zz,” where “zz” are the same numbers for FIG. 6 and FIG. 4.

In more detail, an illustration(s) and/or a description(s) of:
EVs 602, 604, and 606 of FIG. 6 are the same, similar to, and/or equivalent to the EVs 402, 404, and 406 of FIG. 4, respectively;
a communication path(s) 608 of FIG. 6 is the same, similar to, and/or equivalent to the communication path(s) 408 of FIG. 4;
an electricity path(s) 609 of FIG. 6 is the same, similar to, and/or equivalent to the electricity path(s) 409 of FIG. 4;
user-side power meters 630, 632, and 634 of FIG. 6 are the same, similar to, and/or equivalent to the power meter 430, 432, and 434 of FIG. 4, respectively;
EVSEs 610, 612, and 614 of FIG. 6 are the same, similar to, and/or equivalent to the EVSEs 410, 412, and 414 of FIG. 4, respectively;
AC-to-DC converters 611, 613, and 615 of FIG. 6 are the same, similar to, and/or equivalent to the AC-to-DC converters 411, 413, and 415 of FIG. 4, respectively;
a circuit breaker 620 of FIG. 6 is the same, similar to, and/or equivalent to the circuit breaker 420 of FIG. 4; and
a controller 640 of FIG. 6 is the same, similar to, and/or equivalent to the controller 440 of FIG. 4 and/or the system computing device 116 of FIG. 1.

The circuit breaker 620 is coupled to the utility-side power meter 230 (power meter 230) of FIG. 2, and the system 600 may be decoupled from the power grid 200 using the circuit breaker 620. The system 600 may also include BTM resources 650 (e.g., solar panels, on-site batteries). The system 600 may use the BTM resources 650 to generate and deliver AC power to the power grid 200. The power meter 230 may measure and monitor the AC power from the power grid 200 to the system 600 (e.g., FTM electric power) and/or the AC power from the BTM resources 650 to the power grid 200 (e.g., BTM electric power), illustrated as “a bidirectional power flow.” In one aspect, the utility company may provide a credit (e.g., monetary, kWh) to the system 600 for the AC power delivered to the power grid 200 from the BTM resources 650. In another aspect, the system 600 may use the BTM electric power to charge the EVs using the EVSEs, as is illustrated in FIG. 6. Although not explicitly illustrated in FIG. 6, if the BTM electric power includes DC BTM electric power, the system 600 may use the DC BTM electric power to charge the EVs, without using the EVSEs. In yet another aspect, the system 600 may use a BTM-resource-side power meter (not illustrated as such in FIG. 6) to measure the power (AC or DC power) generated by the BTM resources 650.

Similar to the descriptions of FIGS. 4 and 5, in some embodiments, the controller (e.g., controller 640 of FIG. 6) and/or the system computing device 116 of FIG. 1 may store, utilize, and/or selectively execute the first approximation algorithm, the real-time efficiency algorithm, and/or the time-interval efficiency algorithm. It is to be understood that the time-interval efficiency algorithm may enable the system 600 to determine the power conversion efficiency and the power loss associated with the EVSEs 610, 612, and/or 614 efficiently, effectively, and/or accurately.

In one embodiment, the system 600 may use the time-interval efficiency algorithm to determine the efficiency threshold(s) and the output DC power threshold(s) of each EVSE based on power FTM and/or BTM power availability. Next, the description partly focuses on sharing the output DC power.

FIG. 7 illustrates an example system 700 having a plurality of EVSEs that can charge a plurality of EVs, according to one embodiment. FIG. 7 is described in the context of FIGS. 1, 2, 4, and 5. FIG. 7 is not described in the context of FIG. 3. Specifically, the EVSEs of FIG. 7 are DC charging stations. Comparing items (or components) of FIG. 7 to items of FIG. 4, like items in FIG. 4 with numbers “4zz” are the same, similar to, and/or equivalent with like items in FIG. 7 with numbers “7zz,” where “zz” are same numbers for FIG. 7 and FIG. 4.

In more detail, an illustration(s) and/or a description(s) of:
a communication path(s) 708 of FIG. 7 is the same, similar to, and/or equivalent to the communication path(s) 408 of FIG. 4;
an electricity path(s) 709 of FIG. 7 is the same, similar to, and/or equivalent to the electricity path(s) 409 of FIG. 4;
EVSEs 710, 712, and 714 of FIG. 7 are the same, similar to, and/or equivalent to the EVSEs 410, 412, and 414 of FIG. 4, respectively;
AC-to-DC converters 711, 713, and 715 of FIG. 7 are the same, similar to, and/or equivalent to the AC-to-DC converters 411, 413, and 415 of FIG. 4, respectively;
a circuit breaker 720 of FIG. 7 is the same, similar to, and/or equivalent to the circuit breaker 420 of FIG. 4; and
a controller 740 of FIG. 7 is the same, similar to, and/or equivalent to the controller 440 of FIG. 4 and/or the system computing device 116 of FIG. 1.

In FIG. 7, however, each EVSE and/or respective on-site AC-to-DC converters may be coupled to at least two user-side power meters. Specifically, the AC-to-DC converter 711 may be coupled to a first user-side power meter 730 (power meter 730) and a second user-side power meter 731 (power meter 731); the AC-to-DC converter 713 may be coupled to a third user-side power meter 732 (power meter 732) and a fourth user-side power meter 733 (power meter 733); and the AC-to-DC converter 715 may be coupled to a fifth user-side power meter 734 (power meter 734) and a sixth user-side power meter 735 (power meter 735). The power meters 730, 731, 732, 733, 734, and 735 may measure an output DC power (P_{DC}), an output DC current (I_{DC}), and/or an output DC voltage (V_{DC}) to EVs 702, 703, 704, 705, 706, and 707, respectively, as is shown in FIG. 7. It is to be understood that the output DC power (P_{DC}), the output DC current (I_{DC}), and/or the output DC voltage (V_{DC}) are inputs regarding the EVs 702 to 707, and the output DC power (P_{DC}), the output DC current (I_{DC}), and/or the output DC voltage (V_{DC}) are outputs regarding the EVSEs 710, 712, and 714 and/or the respective AC-to-DC converters 711, 713, and 715.

For brevity and clarity, the description discusses DC power sharing of an output DC power (P_{DC}) of the EVSE 710 and/or the AC-to-DC converter 711. The same concepts, however, may be discussed regarding, and/or in association with, other EVSEs and/or AC-to-DC converters that are illustrated in FIG. 7. Continuing with the EVSE 710, the P_{DC} of the EVSE 710 and/or the AC-to-DC converter 711 may charge the EVs 702 and 703, simultaneously. As such, both EVs 702 and 703 may share and/or utilize the same AC-to-DC converter 711 and/or the same EVSE 710 to receive charge. A DC power sharing enables the system 700 to charge a greater count of EVs simultaneously without adding a greater count of certain equipment to do so, for example, without adding a greater count of EVSEs.

Nevertheless, the EVs 702 and 703 may have different SoCs of their respective batteries. Further, the system 700 may use the controller 740 and/or system computing device 116 to enable the system 700 to allocate different amounts of output DC power (and/or electric energy) to the batteries of the EVs 702 and 703. Therefore, the power meters 730 and 731 may measure different amounts of P_{DC}, I_{DC}, and/or V_{DC}.

Continuing with the EVSE 710 and/or the AC-to-DC converter 711, the output DC voltage of the EVSE 710 and/or the AC-to-DC converter 711 may depend on respective voltages of the batteries of the EVs 702 and 703. As forementioned, the voltages of the batteries of the EVs 702 and 703 may depend on SoCs of the EVs 702 and 703. Consequently, the efficiency of the EVSE 710 and/or the AC-to-DC converter 711 may depend on the SoCs of the EVs 702 and 703.

For example, assume the EVSE 710 and/or the AC-to-DC converter 711 can deliver a total of 120 kW. In such a case, the EVSE 710 and/or the AC-to-DC converter 711 can deliver 60 kW to the EV 702 and 60 kW to the EV 703 with a maximum (or higher) power transfer efficiency.

As another example, still assume that the EVSE 710 and/or the AC-to-DC converter 711 can deliver a total of 120 kW. Further, assume that only the EV 702 (that is capable of receiving 60 kW) is coupled to the EVSE 710 and/or the AC-to-DC converter 711. Note that in the latter example, although not illustrated as such in FIG. 7, the EV 703 is not coupled to the EVSE 710 and/or the AC-to-DC converter 711. In such as case, the EVSE 710 and/or the AC-to-DC converter 711 can deliver the 60 kW to the EV 702 at a lower power transfer efficiency, in part due to the fact that the EV 703 is not receiving DC power.

Consequently, in some embodiments, to increase the overall power transfer efficiency of the system 700, the system 700 may communicate with the EVs (e.g., via IVIs of the EVs) to guide the drivers of the EVs to receive DC power from (or at) a certain EVSE. Specifically, the system 700 may maximize a count of the EVs receiving charge from the same EVSE(s), while, for example, leaving some EVSEs uncoupled to the EVs. For example, if the system 700 can simultaneously charge a maximum count of six EVs by using a maximum count of three EVSEs, the system 700 can guide drivers of four EVs to receive charge using only a first or a second EVSEs, while leaving a third EVSE idle.

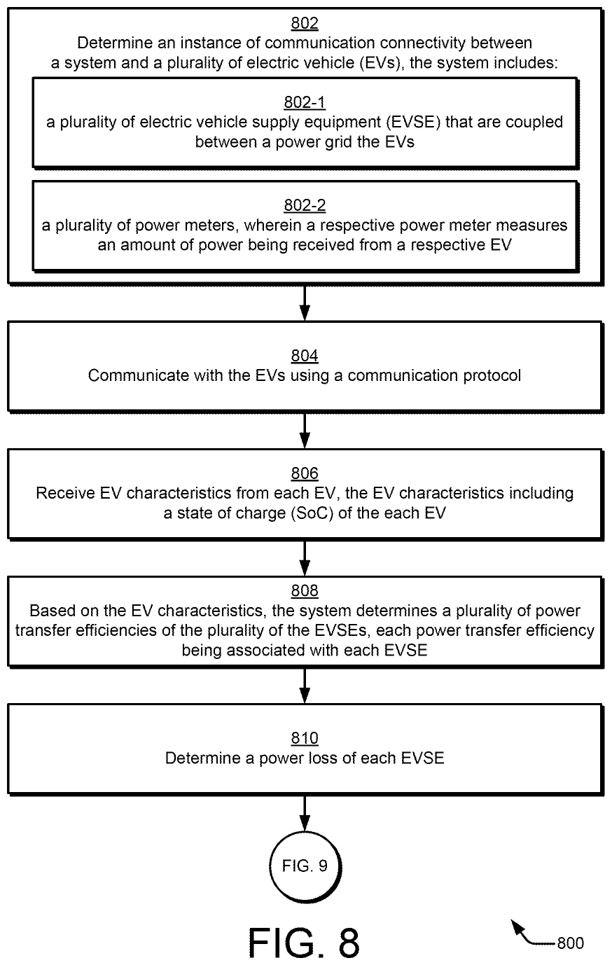

FIG. 8 illustrates a flow diagram 800 for determining power losses associated with each EVSE of the plurality of the EVSEs, according to one embodiment. FIG. 8 is described in the context of FIGS. 1, 2, 4, 5, 6, and 7. FIG. 8 is not described in the context of FIG. 3. Therefore, the EVSEs discussed in FIG. 8 are DC charging stations.

At block 802, the controller (e.g., the controllers 440, 640, or 740) and/or the system computing device 116 of FIG. 1 may determine an instance of communication connectivity between the system (e.g., the systems 100, 400, 600, or 700) and the EVs (e.g., the EVs of FIG. 1, 4, 6, or 7). For clarity, at block 802-1, the flow diagram 800 clarifies that the system includes the EVSEs, and the EVSEs are coupled between the power grid (e.g., the power grid 200) and the EVs. At block 802-2, the flow diagram 800 also clarifies that the system includes user-side power meters (e.g., the power meters 430, 432, and 434 of FIG. 4, the power meters 630, 632, and 634 of FIG. 6, or the power meters 730 to 735 of FIG. 7) to measure the output DC power supplied to each EV. Therefore, it is to be understood that at block 802, the controller and/or the system computing device 116 may determine the instance of communication connectivity between one, more than one, or all the components of the system and the EVs.

After establishing the instance of communication connectivity, at block 804, the controller and/or the system computing device 116 enable(s) the system to communicate with the EVs using any communication protocol and/or standard, including an OCPP; a 3GPP LTE standard; an IEEE 802.11 standard; an IEEE 802.16 standard; an IEEE 802.15.4 standard; a Bluetooth Classic® standard; or a BLE® standard, and/or other protocols and standards established or maintained by various governmental, industry, and/or academia consortiums, organizations, and/or agencies. The controller and/or the system computing device 116 may use the communication path(s) 107 of FIG. 1, the communication path(s) 408 of FIG. 4, the communication path(s) 608 of FIG. 6, the communication path(s) 708 of FIG. 7, or other communication paths that may not be explicitly illustrated in FIGS. 1, 4, 6, and 7.

Using the communication, at block 806, the system receives EV characteristics. The EV characteristics may include an SoC of the EV, a current location of the EV, a planned trip of the EV, a make, model, and/or a vehicle identification number (VIN) of the EV, and/or other EV characteristics. In one aspect, the voltage of the battery of the EV may depend on the SoC of the battery of the EV. Specifically, a higher SoC of the battery may result in a higher voltage of the battery of the EV. However, the output DC voltage (V_{DC}) of each EVSE equals and/or may depend on the voltage of the battery of the EV utilizing each EVSE. Furthermore, the power transfer efficiency of each EVSE partly depends on the output DC voltage of each EVSE. Specifically, the output DC voltage of the EVSE is directly (instead of inversely) related to the power transfer efficiency of the EVSE.

Thus, at block 808, the system determines a plurality of power transfer efficiencies of the EVSEs. Each power transfer efficiency is associated with each EVSE of the plurality of the EVSEs, as is described in FIGS. 4, 5, 6, and 7. To determine the power transfer efficiency of each EVSE, the controller, and/or the system computing device 116 may store, utilize, and/or selectively execute the first-order efficiency approximation algorithm, the real-time efficiency algorithm, the time-interval efficiency algorithm, or a combination thereof. Lastly, after determining the power transfer efficiency of each EVSE, at block 810, the controller and/or the system computing device 116 determines power losses associated with each EVSE. The power losses of each EVSE may not be equal, partly depending on SoCs of respective batteries of the EV. Next, the description partly focuses on electric load balancing.

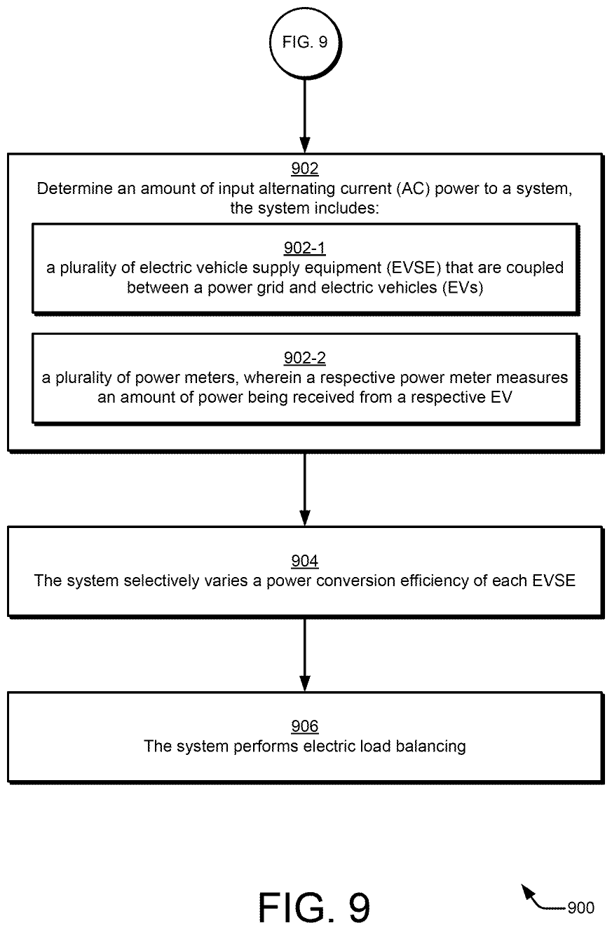

FIG. 9 illustrates a flow diagram 900 for performing electric load balancing (or load balancing) of a plurality of EVSEs and the associated EVs that are receiving charge, according to one embodiment. FIG. 9 is described in the context of FIGS. 1, 2, 4, 5, 6, 7, and 8, and the EVSEs are DC charging stations. However, FIG. 9 also can be partly discussed in the context of FIG. 3 because the system 300 can perform load balancing. Nevertheless, for brevity and clarity, the description of FIG. 9 builds on the description of FIG. 8.

Specifically, after the flow diagram 800 determines the power transfer efficiencies of each EVSE and/or the power losses associated with each EVSE, at block 902, the flow diagram 900 determines an input AC power to the system (e.g., the system 100, the system 400, the system 600, or the system 700). For clarity, at block 902-1, the flow diagram 900 clarifies that the system includes the EVSEs, and the EVSEs are coupled between the power grid (e.g., the power grid 200) and the EVs. At block 902-2, the flow diagram 900 also clarifies that the system includes user-side power meters (e.g., the power meters 430, 432, and 434 of FIG. 4, the power meters 630, 632, and 634 of FIG. 6, or the power meters 730 to 735 of FIG. 7) to measure the output DC power supplied to each EV.

At block 904, the system selectively varies the power conversion efficiency of respective EVSEs supplying respective EVs. For example, due to limitations, such as: the frequency regulation; the available amount of AC power; the available amount of FTM power; the available amount of BTM power; the rating of the electrical service; the setting on the circuit breaker; high energy rates depending on the time of the day, the day of the week, the week of the month, the month of the year; and/or other factors, the controller and/or the system computing device 116 can enable the system to limit an amount of the input AC power being delivered to the EVSEs. In one aspect, the system may limit the amount of the input AC power by selectively varying an amount of the output DC current and/or an amount of the output DC power of each EVSE.

Finally, at block 906, the system performs electric load balancing. In some embodiments, the electric load balancing includes balancing the output DC power of each EVSE and/or the power losses associated with each EVSE. The flow diagram 900 partly describes the system striking a balance between customer needs, power conversion efficiencies of each EVSE, power losses associated with each EVSE, the SoCs of the EVs, limitations on the amount of the input AC power, and/or other forementioned factors.

Next, the description includes additional example embodiments of the described techniques and systems for balancing an electric load by estimating power losses of the DC charging stations.

### Example Embodiments

Example 1. A system for charging a plurality of electric vehicles (EVs), the system comprises: a plurality of electric vehicle supply equipment (EVSE); at least one processor; at least one computer-readable medium having instructions that, responsive to execution by the at least one processor, cause the system to: determine an instance of communication connectivity between the system and the plurality of the EVs; receive EV characteristics from the plurality of the EVs via the instance of communication connectivity, the EV characteristics including a state of charge of each EV of the plurality of EVs; and based on the EV characteristics, determine a plurality of power conversion efficiencies each associated with an EVSE of the plurality of the EVSEs.
Example 2. The system of Example 1, wherein the instructions, responsive to the execution by the at least one processor, further cause the system to determine a power loss of each EVSE of the plurality of the EVSEs based on the associated power conversion efficiency of the plurality of the power conversion efficiencies.
Example 3. The system of Example 2, wherein the instructions, responsive to the execution by the at least one processor, further cause the system to: determine an amount of input alternating current (AC) power to the system; and based on the amount of input AC power to the system and the state of charge of each EV of the plurality of EVs, selectively vary each power conversion efficiency of the plurality of the power conversion efficiencies by selectively varying an output direct current (DC) power of each EVSE of the plurality of the EVSEs.
Example 4. The system of Example 3, wherein the instructions, responsive to the execution by the at least one processor, further cause the system to perform an electric load balancing that comprises balancing the output DC power and the power loss of each EVSE of the plurality of the EVSEs.
Example 5. The system of Example 1 further comprises: a utility-side power meter of a power grid; and at least one switch coupled between the plurality of the EVSEs and the utility-side power meter.
Example 6. The system of Example 5, wherein the utility-side power meter measures, determines, or monitors one or more of an input alternating current (AC) power, an input AC current, an input AC voltage, a frequency of the input AC power, and harmonics of the input AC power.
Example 7. The system of Example 6 further comprises a plurality of user-side power meters coupled between the plurality of the EVSEs and the plurality of the EVs, wherein a respective user-side power meter of the plurality of the user-side power meters measures an amount of electrical power received by a respective EV of the plurality of the EVs.
Example 8. The system of Example 7, wherein the instructions, responsive to the execution by the at least one processor, further cause the system to determine a power loss of each EVSE of the plurality of the EVSEs without utilizing additional power meters.
Example 9. The system of Example 7, wherein each power conversion efficiency of the plurality of the power conversion efficiencies partly depends on one or more of: an input alternating current (AC) voltage to the plurality of the EVSEs; an output direct current (DC) voltage of the each EVSE of the plurality of the EVSEs; and an output DC current of the each EVSE of the plurality of the EVSEs.
Example 10. The system of Example 9, wherein: the input AC voltage is approximately constant; and each power conversion efficiency of the plurality of the power conversion efficiencies increases with one or more of: an increase of the output DC voltage of each EVSE of the plurality of the EVSEs; an increase of the output DC current of each EVSE of the plurality of the EVSEs; and an increase of the state of charge of each EV of the plurality of the EVs.
Example 11. The system of Example 1, wherein the plurality of the EVSEs are direct current (DC) charging stations or Level 3 EVSEs, and the DC charging stations or the Level 3 EVSEs are configured to supply a DC power to the plurality of the EVs.
Example 12. The system of Example 11, wherein each DC charging station or each Level 3 EVSE is configured to supply the DC power to at least two EVs of the plurality of the EVs.
Example 13. The system of Example 1, wherein the instructions comprise an efficiency approximation algorithm, a real-time efficiency algorithm, a time-interval efficiency algorithm, or a combination thereof.
Example 14. The system of Example 1, wherein the at least one processor and the at least one computer-readable medium comprise a controller to communicate with the plurality of the EVSEs, the plurality of the EVs, a utility-side power meter, and a plurality of the user-side power meters using a communication protocol.
Example 15. The system of Example 1, wherein the communication protocol comprises: an Open Charge Point Protocol (OCPP); a Third Generation Partnership Project (3GPP) Long-Term Evolution (LTE) standard; an Institute of Electrical and Electronics (IEEE) 802.11 standard; an IEEE 802.16 standard; an IEEE 802.15.4 standard; a Bluetooth Classic® standard; a Bluetooth Low Energy® (BLE®) standard; or a combination thereof.
Example 16. A computer-implemented method comprising: determining an instance of communication connectivity between a system and a plurality of electric vehicles (EVs), the system comprising: a plurality of electric vehicle supply equipment (EVSE) coupled between a power grid and the plurality of the EVs; and a plurality of power meters, wherein a respective power meter of the plurality of the power meters measuring an amount of power being received from a respective EV of the plurality of the EVs; responsive to determining, the system communicating with the plurality of the EVs using a communication protocol; responsive to communicating with the plurality of the EVs, the system receiving EV characteristics from each EV of the plurality of the EVs, the EV characteristics including a state of charge of each EV of the plurality of the EVs; based on the EV characteristics, the system determining a plurality of power conversion efficiencies each being associated with each EVSE of the plurality of the EVSEs; and responsive to determining the plurality of the power conversion efficiencies, the system determining a power loss of each EVSE of the plurality of the EVSEs.
Example 17. The computer-implemented method of Example 16 further comprising: determining an amount of input alternating current (AC) power to the system from the power grid; based on the amount of input AC power to the system and the state of charge of each EV of the plurality of the EVs, the system selectively varying each power conversion efficiency of the plurality of the power conversion efficiencies by selectively varying an output direct current (DC) power of each EVSE of the plurality of the EVSEs.
Example 18. The computer-implemented method of Example 17 further comprising performing an electric load balancing.
Example 19. The computer-implemented method of Example 16, wherein the plurality of the EVSEs are direct current (DC) charging stations or Level 3 charging stations.
Example 20. A system computing device comprising: an interface to communicate with one or more EVSEs over a network; at least one processor; and at least one computer-readable medium having instructions that, responsive to execution by the at least one processor, cause the system computing device to perform the computer-implemented method of Example 16.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Descriptions is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

A software module, or component may include any type of computer instruction or computer-executable code located within a memory device and/or computer-readable storage medium, as is well known in the art.

It will be obvious to those having skill in the art that many changes may be made to the details of the above-described embodiments without departing from the underlying principles of the invention.

1. A system for charging a plurality of electric vehicles (EVs), the system comprises:
a plurality of electric vehicle supply equipment (EVSE);
at least one processor;
at least one computer-readable medium having instructions that, responsive to execution by the at least one processor, cause the system to:
determine an instance of communication connectivity between the system and the plurality of the EVs;
receive EV characteristics from the plurality of the EVs via the instance of communication connectivity, the EV characteristics including a state of charge of each EV of the plurality of EVs; and
based on the EV characteristics, determine a plurality of power conversion efficiencies each associated with an EVSE of the plurality of the EVSEs.

2. The system of claim 1, wherein the instructions, responsive to the execution by the at least one processor, further cause the system to determine a power loss of each EVSE of the plurality of the EVSEs based on the associated power conversion efficiency of the plurality of the power conversion efficiencies.

3. The system of claim 2, wherein the instructions, responsive to the execution by the at least one processor, further cause the system to:
determine an amount of input alternating current (AC) power to the system; and
based on the amount of input AC power to the system and the state of charge of each EV of the plurality of EVs, selectively vary each power conversion efficiency of the plurality of the power conversion efficiencies by selectively varying an output direct current (DC) power of each EVSE of the plurality of the EVSEs.

4. The system of claim 3, wherein the instructions, responsive to the execution by the at least one processor, further cause the system to perform an electric load balancing that comprises balancing the output DC power and the power loss of each EVSE of the plurality of the EVSEs.

5. The system of claim 1 further comprises:
a utility-side power meter of a power grid; and
at least one switch coupled between the plurality of the EVSEs and the utility-side power meter.

6. The system of claim 5, wherein the utility-side power meter measures, determines, or monitors one or more of an input alternating current (AC) power, an input AC current, an input AC voltage, a frequency of the input AC power, and harmonics of the input AC power.

7. The system of claim 6 further comprises a plurality of user-side power meters coupled between the plurality of the EVSEs and the plurality of the EVs, wherein a respective user-side power meter of the plurality of the user-side power meters measures an amount of electrical power received by a respective EV of the plurality of the EVs.

8. The system of claim 7, wherein the instructions, responsive to the execution by the at least one processor, further cause the system to determine a power loss of each EVSE of the plurality of the EVSEs without utilizing additional power meters.

9. The system of claim 7, wherein each power conversion efficiency of the plurality of the power conversion efficiencies partly depends on one or more of:
an input alternating current (AC) voltage to the plurality of the EVSEs;
an output direct current (DC) voltage of the each EVSE of the plurality of the EVSEs; and
an output DC current of the each EVSE of the plurality of the EVSEs.

10. The system of claim 9, wherein:
the input AC voltage is approximately constant; and
each power conversion efficiency of the plurality of the power conversion efficiencies increases with one or more of:
an increase of the output DC voltage of each EVSE of the plurality of the EVSEs;
an increase of the output DC current of each EVSE of the plurality of the EVSEs; and
an increase of the state of charge of each EV of the plurality of the EVs.

11. The system of claim 1, wherein the plurality of the EVSEs are direct current (DC) charging stations or Level 3 EVSEs, and the DC charging stations or the Level 3 EVSEs are configured to supply a DC power to the plurality of the EVs.

12. The system of claim 11, wherein each DC charging station or each Level 3 EVSE is configured to supply the DC power to at least two EVs of the plurality of the EVs.

13. The system of claim 1, wherein the instructions comprise an efficiency approximation algorithm, a real-time efficiency algorithm, a time-interval efficiency algorithm, or a combination thereof.

14. The system of claim 1, wherein the at least one processor and the at least one computer-readable medium comprise a controller to communicate with the plurality of the EVSEs, the plurality of the EVs, a utility-side power meter, and a plurality of the user-side power meters using a communication protocol.

15. The system of claim 1, wherein the communication protocol comprises:
an Open Charge Point Protocol (OCPP);
a Third Generation Partnership Project (3GPP) Long-Term Evolution (LTE) standard;
an Institute of Electrical and Electronics (IEEE) 802.11 standard;
an IEEE 802.16 standard;
an IEEE 802.15.4 standard;
a Bluetooth Classic® standard;
a Bluetooth Low Energy® (BLE®) standard; or
a combination thereof.

16. A computer-implemented method comprising:
determining an instance of communication connectivity between a system and a plurality of electric vehicles (EVs), the system comprising:
a plurality of electric vehicle supply equipment (EVSE) coupled between a power grid and the plurality of the EVs; and
a plurality of power meters, wherein a respective power meter of the plurality of the power meters measuring an amount of power being received from a respective EV of the plurality of the EVs;
communicating via the system with the plurality of the EVs using a communication protocol;
receiving EV characteristics from each EV of the plurality of the EVs, the EV characteristics including a state of charge of each EV of the plurality of the EVs;
based on the EV characteristics, determining at the system a plurality of power conversion efficiencies each being associated with each EVSE of the plurality of the EVSEs; and
determining at the system a power loss of each EVSE of the plurality of the EVSEs.

17. The computer-implemented method of claim 16 further comprising:
determining an amount of input alternating current (AC) power to the system from the power grid;
based on the amount of input AC power to the system and the state of charge of each EV of the plurality of the EVs, the system selectively varying each power conversion efficiency of the plurality of the power conversion efficiencies by selectively varying an output direct current (DC) power of each EVSE of the plurality of the EVSEs.

18. The computer-implemented method of claim 17 further comprising performing an electric load balancing.

19. The computer-implemented method of claim 16, wherein the plurality of the EVSEs are direct current (DC) charging stations or Level 3 charging stations.

20. A system computing device comprising:
an interface to communicate with one or more EVSEs over a network;
at least one processor; and
at least one computer-readable medium having instructions that, responsive to execution by the at least one processor, cause the system computing device to perform the computer-implemented method of claim 16.
